(19) United States
(12) Patent Application Publication
(10) Pub. No.: US 2026/0355630 A1
(43) Pub. Date: Nov. 12, 2026

(54) BATTLE METHOD, BATTLE APPARATUS, COMPUTER DEVICE, AND STORAGE MEDIUM

(71) Applicant: Tencent Technology (Shenzhen) Company Limited, Shenzhen (CN)

(72) Inventors: Yang CHEN, Shenzhen (CN); Wenbin ZHU, Shenzhen (CN); Shaoyi LUO, Shenzhen (CN); Chunyang WANG, Shenzhen (CN)

(21) Appl. No.: 19/728,564

(22) Filed: Jul. 2, 2026

Related U.S. Application Data
(63) Continuation of application No. PCT/CN2025/107118, filed on Jul. 4, 2025.

(30) Foreign Application Priority Data
Aug. 19, 2024 (CN) 202411144209.5

(51) Int. Cl. A63F 13/56; A63F 13/52; A63F 13/58; A63F 13/822

(52) U.S. Cl. CPC A63F 13/56; A63F 13/52; A63F 13/58; A63F 13/822

(57) ABSTRACT

A method for managing a batter between two virtual characters is performed by a computer device. The method includes: displaying a main control virtual character in a virtual world scene; in response to a trigger event of a turn-based battle, switching the virtual world scene to a battle scene including a first pet character and a second pet character, and the main control virtual character possessing the first pet character; in response to the main control virtual character triggering a first skill of the first pet character, determining a second skill to be cast by the second pet character; and when the first skill overcomes the second skill to be cast by the second pet character, controlling the first pet character to cast the first skill with a bonus effect and controlling the second pet character to cast the second skill.

### CROSS-REFERENCE TO RELATED APPLICATIONS

This application is a continuation application of PCT Patent Application No. PCT/CN2025/107118, entitled “BATTLE METHOD, BATTLE APPARATUS, COMPUTER DEVICE, AND STORAGE MEDIUM” filed on Jul. 4, 2025, which claims priority to Chinese Patent Application No. 202411144209.5, entitled “BATTLE METHOD, BATTLE APPARATUS, COMPUTER DEVICE, AND STORAGE MEDIUM” filed on Aug. 19, 2024, both of which are incorporated herein by reference in their entirety.

### FIELD OF THE TECHNOLOGY

Embodiments of this application relate to the field of computer technologies, and in particular, to a battle method, a battle apparatus, a computer device, and a storage medium.

### BACKGROUND OF THE DISCLOSURE

Open-world games are games that support players to explore to a relatively high degree in a game world, and a map range of the open-world games is usually relatively large. When a player character explores in a game world, a battle often happens.

### SUMMARY

Embodiments of this application provide a battle method, a battle apparatus, a computer device, and a storage medium, to improve an interaction effect and a strategy of a game. The technical solutions are described as follows:

According to one aspect, a method for managing a batter between two virtual characters is performed by a computer device, the method including:
displaying a main control virtual character in a virtual world scene;
in response to a trigger event of a turn-based battle, switching the virtual world scene to a battle scene including a first pet character and a second pet character, and the main control virtual character possessing the first pet character;
in response to the main control virtual character triggering a first skill of the first pet character, determining a second skill to be cast by the second pet character; and
when the first skill overcomes the second skill to be cast by the second pet character, controlling the first pet character to cast the first skill with a bonus effect and controlling the second pet character to cast the second skill.

According to still another aspect, a computer device is provided, including a processor and a memory, the memory having at least one computer program stored therein, and the at least one computer program, when loaded and executed by the processor, causing the computer device to implement operations performed in the method for managing a batter between two virtual characters as described in the above aspects.

According to yet another aspect, a non-transitory computer-readable storage medium is provided, having at least one computer program stored therein, the at least one computer program, when loaded and executed by a processor of a computer device, causing the computer device to implement operations performed in the method for managing a batter between two virtual characters as described in the above aspects.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

### BRIEF DESCRIPTION OF THE DRAWINGS

FIG. 1 is a schematic structural diagram of an implementation environment according to an embodiment of this application.

FIG. 2 is a flowchart of a battle method according to an embodiment of this application.

FIG. 3 is a flowchart of a battle method according to an embodiment of this application.

FIG. 4 is a flowchart of a battle method according to an embodiment of this application.

FIG. 5 is a flowchart of a battle method according to an embodiment of this application.

FIG. 6 is a flowchart of a battle method according to an embodiment of this application.

FIG. 7 is a flowchart of a battle method according to an embodiment of this application.

FIG. 8 is a flowchart of a battle method according to an embodiment of this application.

FIG. 9 is a flowchart of a battle method according to an embodiment of this application.

FIG. 10 is a schematic diagram of animation playing according to an embodiment of this application.

FIG. 11 is a schematic diagram of animation playing according to an embodiment of this application.

FIG. 12 is a flowchart of a battle method according to an embodiment of this application.

FIG. 13 is a schematic diagram of a battle scene according to an embodiment of this application.

FIG. 14 is a schematic diagram of a battle scene according to an embodiment of this application.

FIG. 15 is a schematic diagram of a battle scene according to an embodiment of this application.

FIG. 16 is a schematic diagram of a battle scene according to an embodiment of this application.

FIG. 17 is a schematic diagram of a countering relationship according to an embodiment of this application.

FIG. 18 is a schematic structural diagram of a battle apparatus according to an embodiment of this application.

FIG. 19 is a schematic structural diagram of a terminal according to an embodiment of this application.

FIG. 20 is a schematic structural diagram of a server according to an embodiment of this application.

### DESCRIPTION OF EMBODIMENTS

Terms “first”, “second”, “third”, etc. used in this application may be used for describing various concepts herein, but these concepts are not limited by these terms unless otherwise specified. These terms are merely used for distinguishing one concept from another. For example, without departing from the scope of this application, a first pet character may be referred to as a second pet character, and similarly, the second pet character may be referred to as the first pet character. In terms “at least one”, “a plurality of”, “each”, and “any one” used in this application, “at least one” includes one, two, or more, “a plurality of” include two or more, “each” refers to each of a plurality of corresponding items, and “any one” refers to any one of a plurality of items. For example, a plurality of pet characters include three pet characters, “each” refers to each of the three pet characters, and “any” refers to any of the three pet characters, and may be the first pet character, or the second pet character, or the third pet character.

Information (including but not limited to user equipment information, user personal information, or the like), data (including but not limited to data configured for analysis, stored data, presented data, or the like), and signals involved in this application are all authorized by a user or fully authorized by various parties, and collection, use, and processing of related data need to comply with relevant laws, regulations, and standards of relevant countries and regions. For example, data, instructions, etc. involved in this application are acquired with full authorization.

In a related technology, in a process of a player character and an enemy character battling against each other, a battle result is determined according to attribute values of skills cast by the player character and the enemy character. However, the battle result of this battle mode is only related to the attribute value of the cast skill, and the battle result is relatively undiversified, resulting in a poor interaction effect.

First, terms involved in the embodiments of this application are briefly introduced.

Open-world games refer to games that support players to explore to a high degree in a game world, and a map range of the open-world games is usually relatively large. In this application, a map in an open-world game is a virtual world map.

A turn-based battle refers to a battle mode in which two battle parties perform attack, defense, or attribute improvement in turn according to a turn sequence. Different from an instant battle mode, the turn-based battle pays more attention to a sequence in a battle process. In a implementation, a complete turn in a turn-based battle refers to that all camps in the battle complete active operations of attack, defense, or attribute improvement in turn. In another implementation, a complete turn refers to that a camp A completes an active operation of attack, defense, or attribute improvement. In this application, a map in the turn-based battle is a battle map.

The virtual world map includes a plurality of land parcels. Each land parcel is polygonal. The polygonal land parcel may be any one of square, rectangle, and hexagon. For example, each land parcel is a 50 cm×50 cm square. Each land parcel has an own surface configuration. The surface configuration includes grass, stone, water, and the like. In addition, the plurality of land parcels included in the virtual world map may be of the same type, or a combination of multiple different types.

In some embodiments, the virtual world map of the open-world game will have factors related to time, such as weather, day and night, four seasons, and festivals.

Battle map: The battle map is a partial map in the virtual world map. During the turn-based battle, the battle map in the battle scene and the virtual world map in the virtual world scene use the same piece of map data. In some embodiments, before the turn-based battle, a world server loads the map data of the virtual world map, and during the turn-based battle, a battle server loads the data of a partial map of the virtual world map, so that the battle map shares the same piece of map data with the partial map. For example, in a virtual world scene, when a pet character 1 encounters a wild pet character 2 at a position in a virtual world map to perform a battle, one or more land parcels within a particular range that uses a reference position determined by the pet character 1 as a center in the virtual world map are determined as a battle map. The reference position is a position where the pet character 1 is located, or a suitable battle position closest to the pet character 1. In some embodiments, the battle map includes all land parcels within a circular range that uses the reference position as a center and a preset length as a radius. In some embodiments, the battle map includes all land parcels within a rectangular range that uses the reference position as a center and has a preset length and a preset width.

Virtual world scene and battle scene: The virtual world scene refers to a scene corresponding to the virtual world map. When a user interface displays the virtual world scene, the user interface can display one or more land parcels in the virtual world map. For example, the user interface displays one or more land parcels where the main control virtual character or the pet character is currently located in the virtual world map, as well as some interface elements related to the above displayed land parcels, the main control virtual character, the pet character, and the like. The battle scene refers to a scene corresponding to the battle map. When the user interface displays the battle scene, the user interface can display the battle map, for example, display all or some of land parcels included in the battle map. For example, the user interface displays one or more land parcels where the main control virtual character or the pet character is currently located in the battle map, as well as some interface elements related to the above displayed land parcels, the main control virtual character, the pet character, and the like.

Switching between the virtual world scene and the battle scene can be implemented, for example, from the virtual world scene to the battle scene, or from the battle scene to the virtual world scene.

A virtual camera can adopt different shooting perspectives when the virtual world scene and the battle scene are displayed. For example, when the virtual world scene is displayed, the virtual camera shoots the virtual world scene at a perspective of the main control virtual character (for example, a first-person perspective or a third-person perspective of the main control virtual character), to obtain a display picture of the virtual world scene. When the battle scene is displayed, the virtual camera shoots the battle scene at an intermediate perspective (for example, the virtual camera is located at a position between and obliquely above two parties of the battle), to obtain a display picture of the battle scene. In some embodiments, in the virtual world scene and the battle scene, in addition to the above shooting perspective being different, allowed user operations may also be different. For example, when the virtual world scene is displayed, the user is allowed to manually adjust the perspective, or the user is allowed to control a walking position of the main control virtual character or the pet character; and when the battle scene is displayed, the user is not allowed to manually adjust the perspective, or the user is not allowed to control the walking position of the main control virtual character or the pet character. According to the above mode, the user can make a perceptual distinction between the virtual world scene and the battle scene. The virtual world scene and the battle scene share the same virtual world map, and the battle map used in the battle scene includes one or more land parcels in the virtual world map. Therefore, the switching between the virtual world scene and the battle scene does not make a player feel abrupt, and instead is very smooth and natural switching.

The virtual scene refers to a virtual scene displayed (or provided) when an application program runs on a terminal. The virtual scene may be a simulation environment for the real world, may be a semi-simulation and semi-fiction environment, or may also be a purely fictional environment. The virtual world may be any one of a two-dimensional virtual world, a 2.5-dimensional virtual world, and a three-dimensional virtual world. This is not limited in this application. In the following embodiments, for example, the virtual world is a three-dimensional virtual world.

The main control virtual character refers to a movable object played by a player in the virtual world. The main control virtual character may be a virtual person, a virtual animal, or an animation character, or the like, for example, a person or an animal displayed in the three-dimensional virtual world. In some embodiments, the main control virtual character is a three-dimensional model created based on a skeleton animation technology. Each main control virtual character has a shape and a volume in the three-dimensional virtual world and occupies a part of the space in the three-dimensional virtual world.

The pet character refers to a movable object controlled by artificial intelligence (AI) in the virtual world or by a player. The pet character is a virtual character, which may be a virtual creature, a virtual animal, a virtual monster, a virtual elf, a virtual pet, or the like, for example, a movable object in an animal form or another form displayed in the three-dimensional virtual world. The main control virtual character can perform at least one of interactive operations of capturing, raising, upgrading, and the like on the pet character. The pet character can assist the main control virtual character in at least one of interactive operations of collecting, battling, changing land parcels, and the like. The wild pet character is a movable object controlled by AI in the virtual world.

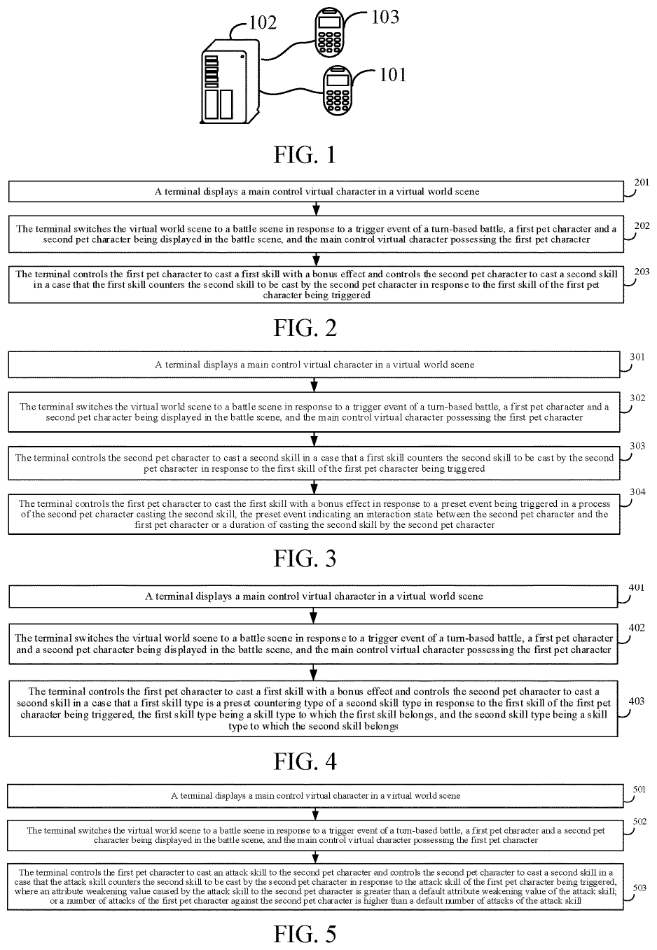

FIG. 1 shows a structural block diagram of a computer system according to an exemplary embodiment of this application. The computer system includes: a first terminal 101, a server 102, and a second terminal 103.

An application program supporting a virtual scene is installed and run on the first terminal 101. In some embodiments, the application program may be any one of a three-dimensional map program, a virtual reality (VR) application program, an augmented reality (AR) program, an open-world game program, a role-playing game (RPG) program, a turn-based game program, and a turn-based RPG program. The first terminal 101 is a terminal used by a first user. The first user uses the first terminal 101 to control a first virtual character in the virtual world scene to perform activities. The first virtual character serves as a main control virtual character of the first terminal 101. The activities include but are not limited to: at least one of adjusting a body posture, walking, running, jumping, riding, driving, aiming, picking up, capturing a pet character, controlling a pet character, raising a pet character, using a pet character to pick, using a pet character to battle, using a throwing prop, and attacking other virtual characters. Exemplarily, the first virtual character is a first virtual person, such as a simulated person object or an animation person object. Exemplarily, the first user controls the first virtual character to perform activities through a user interface (UI) control on a virtual scene picture, and the first user controls the first virtual character to throw a pet character through the UI control on the virtual scene picture. An application program supporting a virtual scene is installed and run on the second terminal 103. The second terminal 103 is a terminal used by a second user. The second user uses the second terminal 103 to control a second virtual character in the virtual world scene to perform activities. The second virtual character serves as a main control virtual character of the second terminal 103. In some embodiments, the first virtual character and the second virtual character are in a same virtual world scene. The first virtual character and the second virtual character belong to different camps, or the first virtual character and the second virtual character belong to the same camp.

The first terminal 101 is connected to the server 102 through a wireless network or a wired network. The second terminal 103 is connected to the server 102 through a wireless network or a wired network. The server 102 is configured to provide a background service for an application program supporting a three-dimensional virtual scene. The server 102 includes at least one of a server, a plurality of servers, a cloud computing platform, and a virtualization center. Exemplarily, the server 102 includes a processor and a memory. The memory includes a receiving module, a control module, and a transmitting module. The receiving module is configured to receive a request transmitted by a client, such as a request for investigating a position of an enemy virtual character. The control module is configured to control rendering of a virtual scene picture. The transmitting module is configured to transmit a response to the client, for example, transmit the position of the enemy virtual character to the client. In some embodiments, the server 102 undertakes primary computing work, and the first terminal 101 and the second terminal 103 undertake secondary computing work; or the server 102 undertakes secondary computing work, and the first terminal 101 and the second terminal 103 undertake primary computing work; or the server 102, the first terminal 101, and the second terminal 103 perform collaborative computing by using a distributed computing architecture among each other.

In some embodiments, the application programs installed on the first terminal 101 and the second terminal 103 are the same, or the application programs installed on the three terminals are the same type of application programs on different operating system platforms. The first terminal 101 may refer to one of a plurality of terminals, and the second terminal 103 may refer to one of a plurality of terminals. In this embodiment, only the first terminal 101 and the second terminal 103 are used as an example for description. Device types of the first terminal 101 and the second terminal 103 are the same or different. The device type includes at least one of a smart phone, a smart watch, a smart TV, a tablet computer, a wearable device, a vehicle-mounted terminal, an MP3 player, an MP4 player, a laptop computer, and a desktop computer. In the following embodiments, an example in which a terminal includes a smart phone is taken for description.

A person skilled in the art may know that there may be more or fewer of the foregoing terminals. For example, there may be only one terminal, or there may be dozens of or hundreds of the foregoing terminals or more. The embodiments of this application do not limit the number and device types of terminals.

FIG. 2 is a flowchart of a battle method according to an embodiment of this application. For example, the method is performed by a terminal. As shown in FIG. 2, the method includes the following:

201: a terminal displays a main control virtual character in a virtual world scene.

In this embodiment of this application, the terminal displays the main control virtual character in the virtual world scene, and the main control virtual character possesses pet characters. When a trigger event of a turn-based battle in the virtual world scene is triggered, the pet character of the main control virtual character can battle with other pet characters. During the battle, the pet character participating in the battle can cast a skill, and skills cast by different pet characters may have a countering relationship. When the skill cast by any pet character counters the skill cast by another pet character, a skill effect of the skill cast by the pet character may receive a bonus.

The virtual world scene is a scene corresponding to a virtual world map, that is, a scene corresponding to a virtual world, and is also referred to as a virtual scene. In some embodiments, the virtual world map has many map resources for the main control virtual character controlled by a player to explore, and the virtual world scene is also referred to as a “big world scene”. The main control virtual character displayed in the virtual world scene is a virtual character controlled by the local end.

202: The terminal switches the virtual world scene to a battle scene in response to a trigger event of a turn-based battle, a first pet character and a second pet character being displayed in the battle scene, and the main control virtual character possessing the first pet character.

In this embodiment of this application, the trigger event of the turn-based battle is configured for unfolding the turn-based battle of the pet character. In this case, the virtual world scene is switched to the battle scene in response to the trigger event of the turn-based battle, so that the pet character participating in the battle is displayed in the battle scene. Subsequently, the user can control the pet character to battle with other pet characters in the battle scene through the terminal.

The first pet character is a pet character possessed by the main control virtual character, and is also equivalent to a pet character controlled by the local end. The second pet character is a pet character controlled by artificial intelligence in the virtual world scene, or is a pet character possessed by a main control virtual character of another player. In this embodiment of this application, when the second pet character is a pet character controlled by artificial intelligence in the virtual world scene, the second pet character may also be referred to as a wild pet character in the virtual world scene; and when the second pet character is a pet character possessed by the main control virtual character of another player, the second pet character is also equivalent to a pet character controlled by another player.

In this embodiment of this application, when the trigger event of the turn-based battle is triggered, the first pet character and the second pet character may already be displayed in the virtual world scene; or only the first pet character may be displayed; or only the second pet character may be displayed; or the first pet character and the second pet character may not be displayed. For example, the second pet character is a wild pet character in the virtual world scene. When the player controls the main control virtual character to perform activities in the virtual world scene through the terminal and the main control virtual character encounters the second pet character, the main control virtual character controlled by the local end and the second pet character are displayed in the virtual world scene. For another example, the second pet character is a wild pet character in the virtual world scene, and the player can control the first pet character possessed by the main control virtual character to be set to follow through the terminal. When the player controls the main control virtual character to perform activities in the virtual world scene through the terminal, the main control virtual character can be displayed in the virtual world scene, and the first pet character is displayed to move with the main control virtual character. When the main control virtual character encounters the second pet character in the virtual world scene, the main control virtual character controlled by the local end, the first pet character, and the second pet character are displayed in the virtual world scene. For another example, the second pet character is a pet character possessed by the main control virtual character of another player. Taking an example in which the main control virtual character possessing the first pet character is the first virtual character, and the main control virtual character possessing the second pet character is the second virtual character, the first player can control the first virtual character to perform activities in the virtual world scene through the terminal. The second player can control the second pet character possessed by the second virtual character to be set to follow through the terminal. When the second player controls the second virtual character to perform activities in the virtual world scene through the terminal, the second virtual character can be displayed in the virtual world scene, and the second pet character is displayed to move with the second virtual character. When the first virtual character encounters the second virtual character in the virtual world scene, the first virtual character controlled by the local end, the second virtual character, and the second pet character are displayed in the virtual world scene. For another example, taking an example in which the main control virtual character possessing the first pet character is the first virtual character, and the main control virtual character possessing the second pet character is the second virtual character, the first player can control the first virtual character to perform activities in the virtual world scene through the terminal. The second player can control the second virtual character to perform activities in the virtual world scene through the terminal. When the first virtual character encounters the second virtual character in the virtual world scene, the first virtual character controlled by the local end and the second virtual character are displayed in the virtual world scene.

203: The terminal controls the first pet character to cast a first skill with a bonus effect and controls the second pet character to cast a second skill when the first skill overcomes the second skill to be cast by the second pet character in response to the first skill of the first pet character being triggered.

In some embodiments, in response to the main control virtual character triggering a first skill of the first pet character, the terminal determines a second skill to be cast by the second pet character. When the first skill overcomes the second skill to be cast by the second pet character, the terminal controls the first pet character to cast the first skill with a bonus effect and controls the second pet character to cast the second skill. In this embodiment of this application, in the battle scene, both the first pet character and the second pet character can cast skills to battle against each other. In addition, there may be a countering relationship between different skills, and a bonus effect may be received when a skill that counters another skill is cast. When the battle scene is displayed, the user can select a skill to be cast for the first pet character through the terminal. That the first skill of the first pet character is triggered is equivalent to that the user selects the first skill as a skill to be cast by the first pet character through the terminal, that is, selects the first skill for the first pet character. The second skill is a skill to be cast by the second pet character. The first skill is a skill of any type. For example, the first skill is an attack skill, a defense skill, or a state updating skill. The second skill is a skill countered by the first skill. For example, when the first skill is an attack skill, the second skill is a state updating skill. When the first skill is a defense skill, the second skill is an attack skill. When the first skill is a state updating skill, the second skill is a defense skill.

In this embodiment of this application, each skill corresponds to a default effect, and the default effect indicates an effect generated when the skill is cast in a common state. However, when a skill overcomes another skill, when the skill is cast, a bonus effect is generated, and the bonus effect can indicate a skill effect additionally added based on an original default skill effect. For example, the skill is an attack skill, and a default effect of the attack skill is to cause an attack damage to an attacked party to reduce a health point of the attacked party by 50; when the attack skill is cast with a bonus effect, an attack damage is caused to the attacked party to reduce the health point of the attacked party by 50, and reduce a defense attribute of the attacked party; or when the attack skill is cast with a bonus effect, an attack damage is caused to the attacked party to reduce the health point of the attacked party by 150.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2 above, in this embodiment of this application, the second pet character is first controlled to cast the second skill, and the first pet character is controlled to cast the first skill with a bonus effect only when the preset event is triggered. For a specific process, refer to the following embodiment. FIG. 3 is a flowchart of a battle method according to an embodiment of this application. For example, the method is performed by a terminal. As shown in FIG. 3, the method includes the following:

301: A terminal displays a main control virtual character in a virtual world scene.

302: The terminal switches the virtual world scene to a battle scene in response to a trigger event of a turn-based battle, a first pet character and a second pet character being displayed in the battle scene, and the main control virtual character possessing the first pet character.

In a implementation, a trigger event of a turn-based battle indicates that in the virtual world scene, the main control virtual character or the pet character possessed by the main control virtual character enters a battle range of a wild pet character, where the battle range may be any range, for example, the battle range is a circular range that uses the position of the wild pet character as a center and any distance as a radius; or the battle range is a rectangular range that uses the position of the wild pet character as a center. In this embodiment of this application, the wild pet character in the virtual world scene has a corresponding battle range, and if any main control virtual character or any other pet character enters the battle range of the wild pet character, it indicates a trigger event of a turn-based battle with the wild pet character being triggered. In this embodiment of this application, the wild pet character is the second pet character, that is, the terminal switches the virtual world scene to the battle scene in response to the main control virtual character or any other pet character possessed by the main control virtual character entering the battle range of the second pet character.

In a implementation, a trigger event of a turn-based battle instructs the main control virtual character to throw a virtual prop to the wild pet character in the virtual world scene. The virtual prop is a prop of any type, for example, the virtual prop is a prop that initiates a battle, or a virtual prop in which a pet character is stored. In this embodiment of this application, when controlling the main control virtual character to perform activities in the virtual world scene through the terminal, the user can control the main control virtual character to throw the virtual prop to the wild pet character, so as to initiate a turn-based battle with the wild pet character.

In some embodiments, throwing the virtual prop in which the pet character is stored to the wild pet character is equivalent to initiating a turn-based battle between the pet character stored in the virtual prop and the wild pet character. For example, the wild pet character is the second pet character, the terminal casts the first pet character in the virtual prop in response to the main control virtual character throwing the virtual prop in which the first pet character is stored to the wild pet character, the first pet character finds that the wild virtual character exists around the first pet character, and then, the first pet character actively initiates a turn-based battle to the second pet character.

In a implementation, a first main control virtual character encounters a second main control virtual character in the virtual world scene, and during a conversation between the first main control virtual character and the second main control virtual character, in response to the first main control virtual character initiating a battle to the second main control virtual character, when the second main control virtual character confirms participation in the battle, the virtual world scene is switched to the battle scene; or the first main control virtual character encounters the second main control virtual character in the virtual world scene, the first main control virtual character raids the second main control virtual character, and the second main control virtual character is forced to enter a turn-based battle. In this embodiment of this application, during the conversation between the first main control virtual character and the second main control virtual character, in response to the first main control virtual character initiating a battle to the second main control virtual character, it is equivalent to that a trigger event of a turn-based battle is triggered. The first main control virtual character raiding the second main control virtual character is equivalent to that a trigger event of a turn-based battle is triggered. The first main control virtual character or the second main control virtual character is a main control virtual character controlled by the local end. Taking an example in which the first main control virtual character is the main control virtual character controlled by the local end, the second main control virtual character is a non-player character (NPC) set in the game, or the main control virtual character controlled by another player.

In a implementation, operation 302 includes: playing a scene switching animation in response to the trigger event of the turn-based battle, and displaying the battle scene when the scene switching animation ends. In this embodiment of this application, the scene switching animation is configured for displaying a process of switching from the virtual world scene to the battle scene. By playing the animation, smooth transition during scene switching can be ensured, and a display effect of scene switching can be ensured.

In some embodiments, the scene switching animation includes: a picture in which the main control virtual character uses a virtual prop, and casts the first pet character from the virtual prop; or a picture in which the enemy virtual character provokes the main control virtual character. In this embodiment of this application, the main control virtual character uses the virtual prop, and casts the first pet character from the virtual prop, indicating that the main control virtual character casts the first pet character to participate in the battle. The picture in which the enemy virtual character provokes the main control virtual character can reflect a process of our main control virtual character interacting with the enemy virtual character to battle. The enemy virtual character is an enemy main control virtual character or a pet character possessed by the enemy main control virtual character, and the enemy main control virtual character is a main control virtual character controlled by another terminal.

303: The terminal controls the second pet character to cast a second skill when a first skill overcomes the second skill to be cast by the second pet character after the first skill by the first pet character being triggered.

In this embodiment of this application, when the first pet character is about to cast the first skill and the second pet character is about to cast the second skill, because the first skill overcomes the second skill, the second pet character is first controlled to cast the second skill; and then, in response to the preset event being triggered, the first pet character is controlled to cast the second skill with a bonus effect. This can highlight the case in which the first pet character casts the second skill with a bonus effect, so that the user can learn which skill is countered by viewing the displayed picture, thereby reflecting a countering situation between two skills, and ensuring a control accuracy and an interaction effect between pet characters.

In a implementation, in a turn-based battle process, in a current turn, after the first skill by the first pet character being triggered and a received first cast instruction, when the first skill overcomes the second skill to be cast by the second pet character, the second pet character is controlled to cast the second skill. The first cast instruction instructs the second pet character to wait to cast the second skill in the current turn. The first cast instruction is transmitted by the server. In some embodiments, if the second pet character is an artificial intelligence pet character, the server determines the second skill to be cast by the second pet character for the second pet character, generates the first cast instruction, and transmits the first cast instruction to the terminal. If the second pet character is a pet character possessed by a main control virtual character controlled by another user, taking an example in which a terminal corresponding to the first pet character is a first terminal and a terminal corresponding to the second pet character is a second terminal, the second terminal transmits a first cast instruction to the server in response to the second skill of the second pet character being triggered in the current turn, and the server transmits the first cast instruction to the first terminal when receiving the first cast instruction transmitted by the second terminal.

In this embodiment of this application, the turn-based battle includes a plurality of turns. In each turn, the user triggers any skill of the first pet character through the terminal, that is, the user selects a skill for the first pet character through the terminal, so that the first pet character casts the selected skill in the current turn to battle with the second pet character. For the second pet character, if the second pet character is an artificial intelligence pet character, the server determines the second skill to be cast by the second pet character in the current turn for the second pet character. If the second pet character is a pet character controlled by the second terminal, another user triggers any skill of the second pet character in the current turn through the second terminal, that is, another user selects a skill for the second pet character through the second terminal, so that the second pet character casts the selected skill in the current turn to battle with the first pet character.

In some embodiments, the second pet character is an artificial intelligence pet character. Each turn includes a preparation stage or a battle stage. In the preparation stage of the current turn, after the casting of the first skill by the first pet character being triggered, a second cast instruction is obtained, and the first cast instruction transmitted by the server is received. After the countdown of the preparation stage ends, the battle stage of the current turn is performed. In the battle stage of the current turn, in response to the first cast instruction and the second cast instruction, when the first skill overcomes the second skill to be cast by the second pet character, the second pet character is controlled to cast the second skill. The second cast instruction instructs the first pet character to wait to cast the first skill in the current turn. In this embodiment of this application, the countering relationship between the first skill and the second skill is determined by the terminal or the server. When the countering relationship between the first skill and the second skill is determined by the terminal, the terminal queries a skill mapping relationship in response to the first cast instruction and the second cast instruction to determine that the first skill overcomes the second skill. When the countering relationship between the first skill and the second skill is determined by the server, the terminal obtains the second cast instruction after the casting of the first skill by the first pet character being triggered in the preparation stage of the current turn, and transmits the second cast instruction to the server; the server queries the skill mapping relationship in response to the first cast instruction and the second cast instruction to determine that the first skill overcomes the second skill, and transmits skill overcoming information to the terminal, the skill overcoming information indicating the countering relationship between the first skill and the second skill; and then, the terminal receives the skill overcoming information. After the countdown of the preparation stage ends, the battle stage of the current turn is performed. In the battle stage of the current turn, in response to the first cast instruction and the second cast instruction, when the skill overcoming information indicates that the first skill overcomes the second skill, the second pet character is controlled to cast the second skill.

The skill mapping relationship indicates a countering situation between skills. For example, the skill mapping relationship includes a plurality of skills and skills countered by each skill, or the skill mapping relationship includes a plurality of skill types and a countering relationship between every two skill types. The skill type is a type to which a skill of each pet character belongs. For example, the skill type includes an attack type, a defense type, a state updating type, or the like. In the skill mapping relationship, a skill of the attack type counters a skill of the defense type, a skill of the defense type counters a skill of the state updating type, and a skill of the state updating type counters a skill of the attack type.

In some embodiments, the second pet character is a pet character possessed by a main control virtual character controlled by another user through the terminal. Taking an example in which a terminal corresponding to the first pet character is a first terminal and a terminal corresponding to the second pet character is a second terminal, each turn includes a preparation stage or a battle stage. In the preparation stage of the current turn, the first terminal obtains the second cast instruction after the casting of the first skill by the first pet character being triggered, and transmits the second cast instruction to the server; the server transmits the second cast instruction to the second terminal when receiving the second cast instruction, and the second terminal receives the second cast instruction; the second terminal obtains the first cast instruction in response to the second skill of the second pet character being triggered, and transmits the first cast instruction to the server; the server transmits the first cast instruction to the first terminal when receiving the first cast instruction, and the first terminal receives the first cast instruction; in the battle stage of the current turn, the first terminal controls the second pet character to cast the second skill when the first skill overcomes the second skill to be cast by the second pet character in response to the first cast instruction and the second cast instruction; and the second terminal controls the second pet character to cast the second skill when the first skill overcomes the second skill to be cast by the second pet character in response to the first cast instruction and the second cast instruction.

In this embodiment of this application, the countering relationship between the first skill and the second skill is determined by the terminal or the server. When the countering relationship between the first skill and the second skill is determined by the terminal, the first terminal or the second terminal queries the skill mapping relationship respectively in response to the first cast instruction and the second cast instruction to determine that the first skill overcomes the second skill; or when the countering relationship between the first skill and the second skill is determined by the server, the server queries the skill mapping relationship in response to the first cast instruction and the second cast instruction when receiving the first cast instruction and the second cast instruction to determine that the first skill overcomes the second skill, and respectively transmits skill overcoming information to the first terminal and the second terminal, the skill overcoming information indicating the countering relationship between the first skill and the second skill; and then, the first terminal and the second terminal receive the skill overcoming information. After the countdown of the preparation stage ends, the battle stage of the current turn is performed. In the battle stage of the current turn, the first terminal and the second terminal control the second pet character to cast the second skill when the skill overcoming information indicates that the first skill overcomes the second skill in response to the first cast instruction and the second cast instruction.

In a implementation, the second pet character is controlled to cast the second skill with a default effect. In this embodiment of this application, each skill corresponds to a default effect, and the default effect indicates an effect generated when the skill is cast in a common state. When the second skill is countered, by controlling the second pet character to cast the second skill with a default effect, it can be reflected that the second skill of the second pet character does not counter the first skill to be cast by the first pet character, thereby ensuring an accuracy of game data. For example, the second skill is an attack skill, a default effect of the attack skill is “causing a physical attack damage by 50 to the opposite pet character”, and the second pet character is controlled to cast the second skill with a default effect.

In a implementation, the process of casting the second skill by the second pet character includes: controlling the second pet character to cast the second skill with a weakening effect. In this embodiment of this application, when a skill is countered, a skill effect caused when the skill is cast is weakened. The weakening effect can indicate that the skill effect of the skill is weakened based on an original default skill effect. When the second skill is countered, by controlling the second pet character to cast the second skill with a weakening effect, it can be reflected that the second skill of the second pet character is countered by the first skill to be cast by the first pet character, thereby ensuring the accuracy of game data. The user can learn which skill is countered by viewing the displayed picture, thereby reflecting a countering situation between two skills, and ensuring the control accuracy and the interaction effect between pet characters. In addition, in a battle process, the effect bonus is applied to the skill that counters a skill cast by the opposite party, and a skill effect of the countered skill is weakened, so that a battle progress can be further accelerated, one of two battle parties can defeat the opposite party as soon as possible, and the turn-based battle can be ended without performing excessive turns. In this case, the user can end the turn-based battle without triggering excessive operations, thereby improving the human-computer interaction efficiency. For example, the second skill is an attack skill, a default effect of the attack skill is “causing a physical attack damage by 50 to the opposite pet character”, and a weakening effect of the attack skill is “causing a physical attack damage by 30 to the opposite pet character”.

304: The terminal controls the first pet character to cast the first skill with a bonus effect in response to a preset event being triggered in a process of the second pet character casting the second skill, the preset event indicating an interaction state between the second pet character and the first pet character or a duration of casting the second skill by the second pet character.

In this embodiment of this application, in the process of the second pet character casting the second skill, it indicates that the second pet character is casting, and has not cast the second skill completely. The preset event is configured for representing a moment at which the first pet character casts the first skill with a bonus effect. The interaction state refers to a state in which the first pet character interacts with the second pet character. For example, taking an example in which the first skill is a defense skill and the second skill is an attack skill, the interaction state indicated by the preset event is a state in which the second pet character is about to attack the first pet character in the process of the second pet character casting the attack skill against the first pet character. The duration for which the second pet character casts the second skill is any duration. For different skills, the durations indicated by the preset event may be the same or may be different. When the preset event indicates the duration for which the second pet character casts the second skill, it indicates that the first pet character is controlled to cast the first skill with a bonus effect when the duration for which the second pet character casts the second skill reaches the duration specified by the preset event. For example, the preset event indicates that the duration for which the second pet character casts the second skill is one second, and in the process of the second pet character casting the second skill, if the duration for which the second pet character casts the second skill reaches one second, which is equivalent to that the preset event is triggered, the first pet character is controlled to cast the first skill with a bonus effect.

In this embodiment of this application, when the first pet character is controlled to cast the first skill with a bonus effect, the second pet character may continue to cast the second skill, or a cast of the second skill may be completed.

In a implementation, the method further includes: controlling the second pet character to suspend a cast of the second skill in response to the preset event being triggered. In this embodiment of this application, in response to the preset event being triggered, the second pet character is controlled to suspend the cast of the second skill. Suspending the cast of the second skill is equivalent to a bonus effect of the first skill. That is, when the first skill overcomes the second skill, the first skill can further interrupt the cast of the second skill while ensuring a default effect. In this turn, only the first pet character successfully casts the first skill, and the cast of the second skill by the second pet character is interrupted, thereby reflecting that a bonus effect of the first skill is to interrupt the skill of the opposite party to improve the interaction effect between pet characters; and different skill effects can be achieved without the need to perform excessive operations by the user, thereby improving the human-computer interaction efficiency.

In this embodiment of this application, the second pet character is first controlled to cast the second skill, and the first pet character is controlled to cast the first skill with a bonus effect only when the preset event is triggered. In another embodiment, there is no need to perform operations 303 to 304 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2, in this embodiment of this application, a countering relationship between skills is determined based on the skill type to which the skill belongs. For a specific process, refer to the following embodiment. FIG. 4 is a flowchart of a battle method according to an embodiment of this application. For example, the method is performed by a terminal. As shown in FIG. 4, the method includes the following:

401: A terminal displays a main control virtual character in a virtual world scene.

402: The terminal switches the virtual world scene to a battle scene in response to a trigger event of a turn-based battle, a first pet character and a second pet character being displayed in the battle scene, and the main control virtual character possessing the first pet character.

Operations 401 to 402 are similar to operations 301 to 302 mentioned above. Details are not described herein again.

403: The terminal controls the first pet character to cast a first skill with a bonus effect and controls the second pet character to cast a second skill when a first skill type is a preset overcoming type of a second skill type after the casting of the first skill by the first pet character being triggered, the first skill type being a skill type to which the first skill belongs, and the second skill type being a skill type to which the second skill belongs.

In this embodiment of this application, each skill belongs to a skill type, and skill types to which different skills belong may be the same or may be different. A countering relationship is set between multiple skill types. When a countering relationship exists between skill types of two skills, it indicates that a countering relationship exists between the two skills. The countering relationship between the first skill and the second skill is determined based on the countering relationship between the skill types of the first skill and the second skill, so as to ensure the accuracy of the determined countering relationship, and further ensure the accuracy of the skill cast based on the countering relationship. The first skill type is a preset overcoming type of the second skill type, which is equivalent to that the first skill overcomes the second skill. For example, the plurality of skill types include an attack type, a defense type, and a state updating type. A skill of the attack type counters a skill of the defense type, a skill of the defense type counters a skill of the state updating type, and a skill of the state updating type counters a skill of the attack type. The default effect of the skill of the attack type is to reduce the health point of the opposite pet character. The default effect of the skill of the defense type is to achieve parry damage reduction, that is, reduce the damage caused by the opposite pet character to our pet character. The default effect of the skill of the state updating type is to increase the state of the skill or reduce the state of the opposite pet character.

In a implementation, the process of casting the first skill includes: controlling the first pet character to cast the first skill with a bonus effect when an energy value possessed by the first pet character is not less than a value corresponding to the first skill, and reducing the energy value possessed by the first pet character by the value corresponding to the first skill, the value corresponding to the first skill being an energy value consumed when the first skill is cast. In this embodiment of this application, the pet character possesses an energy value, and the pet character consumes the possessed energy value when casting a skill. When the first pet character casts the first skill, when the energy value currently possessed by the first pet character can satisfy the consumption of casting the first skill, the first pet character can successfully cast the first skill; and when the energy value currently possessed by the first pet character cannot satisfy the consumption of casting the first skill, the first pet character cannot cast the first skill. The pet character is controlled to cast the skill by using the energy value possessed by the pet character. Only when the energy value possessed by the first pet character is not less than the value corresponding to the first skill, the first pet character can be controlled to cast the first skill with a bonus effect, and the energy value possessed by the first pet character is reduced by the value corresponding to the first skill, so as to ensure that the energy value possessed by the first pet character is updated, thereby ensuring the accuracy of game data. In addition, when selecting a skill to be cast for the pet character, the user needs to consider the energy value possessed by the pet character, so as to enhance the strategy of the game and improve the fun of the game, thereby improving the game experience.

The value corresponding to the first skill is any value, and different skills may consume the same or different energy values when being cast. The energy value possessed by the first pet character is any value. In some embodiments, the first pet character corresponds to an upper limit of an energy value, the energy value possessed by the first pet character is not greater than the upper limit of the energy value corresponding to the first pet character, and the upper limit of the energy value is a maximum energy value that the first pet character can possess. In this embodiment of this application, upper limits of energy values corresponding to different pet characters may be the same or may be different. For example, an upper limit of an energy value corresponding to each pet character in the virtual world scene is 10. In this embodiment of this application, the terminal controls the first pet character to cast the first skill with a bonus effect and controls the second pet character to cast the second skill when the energy value possessed by the first pet character is not less than the value corresponding to the first skill and the first skill overcomes the second skill after the casting of the first skill by the first pet character being triggered.

In some embodiments, the terminal checks the energy value possessed by the first pet character and the value corresponding to the first skill after the casting of the first skill by the first pet character being triggered; determines that the first skill is successfully triggered when the check succeeds, and then performs subsequent operations; and displays prompt information when the check fails, the prompt information being configured for prompting that the energy value currently possessed by the first pet character cannot satisfy the consumption of casting the first skill. In this embodiment of this application, if the check succeeds, it indicates that the energy value possessed by the first pet character is not less than the value corresponding to the first skill; and if the check fails, it indicates that the energy value possessed by the first pet character is less than the value corresponding to the first skill. When detecting a trigger operation on the first skill, the terminal first checks the energy value possessed by the first pet character and the value corresponding to the first skill, so as to check whether the energy value currently possessed by the first pet character satisfies the consumption of casting the first skill; and only when the check succeeds, it is determined that the first skill is successfully triggered. In this way, the situation where the first skill is successfully triggered but the energy value currently possessed by the first pet character is insufficient is avoided, thereby ensuring the accuracy of game data. In addition, when the check fails, prompting is performed by displaying prompt information, so that the user learns that the first skill cannot be selected for the first pet character currently, thereby improving the user experience.

In some embodiments, the energy value possessed by the pet character can also be recovered, and a process of recovering the energy value possessed by the pet character includes at least one of the following items.

First item: Increase the energy value possessed by the first pet character when the first pet character is located in an energy recovery area in the virtual world scene. In this embodiment of this application, the energy recovery area exists in the virtual world scene. When the first pet character does not participate in the turn-based battle, the user can control the first pet character to perform activities in the virtual world scene through the terminal, so as to control the first pet character to enter the energy recovery area, thereby increasing the energy value possessed by the first pet character, implementing a mode of recovering the energy value possessed by the pet character, ensuring that the pet character supplements the possessed energy value in time after the turn-based battle, avoiding the situation that the energy value possessed by the pet character cannot satisfy skill cast when the next turn-based battle starts, ensuring the subsequent interaction effect between the pet character and other pet characters, and also improving the user experience. The energy recovery area is an area at any position in the virtual world scene. For example, a plurality of virtual energy pools are provided in the virtual world scene, the virtual energy pools are configured to provide energy values, and a circular area using the virtual energy pools as a center and having a preset radius is used as the energy recovery area.

In a implementation, the first item includes: displaying that the energy value possessed by the first pet character gradually increases when the first pet character is located in the energy recovery area; or displaying that the energy value possessed by the first pet character is increased by a preset value when the first pet character is located in the energy recovery area.

In this embodiment of this application, when the first pet character is located in the energy recovery area, it is displayed that the energy value possessed by the first pet character gradually increases, and a dynamic effect that the first pet character gradually recovers the energy value can be reflected to ensure a display effect for facilitating the viewing of the user, thereby improving the user experience. In this embodiment of this application, each energy recovery area can only recover the energy of a preset value. When the first pet character is located in the energy recovery area, the energy value possessed by the first pet character is increased by the preset value, so that each time the first pet character enters the energy recovery area, only an energy value of a particular value can be recovered. In this way, when the energy value possessed by the first pet character is insufficient, the player is enabled to control the first pet character to enter another energy recovery area to recover the energy value, and the player is enabled to interact with the first pet character, thereby improving the interaction effect.

In some embodiments, in the process of the energy value possessed by the first pet character gradually increasing, if the energy value possessed by the first pet character reaches the upper limit of the energy value corresponding to the first pet character, the energy value possessed by the first pet character does not increase any more.

This embodiment of this application is described by taking an example in which the first pet character enters the energy recovery area. In another embodiment, when the main control virtual character is located in the energy recovery area in the virtual world scene, the energy value possessed by each pet character possessed by the main control virtual character is increased.

Second item: Increase the energy value possessed by the first pet character when the battle between the first pet character and the second pet character ends. In this embodiment of this application, the battle between the first pet character and the second pet character ends means that the turn-based battle of this time ends. When the turn-based battle ends, the energy value of the first pet character is increased to ensure that the energy value of the first pet character can satisfy the next turn-based battle, thereby avoiding the situation that the energy value of the first pet character cannot satisfy skill cast when the next turn-based battle starts, and ensuring the subsequent battle effect.

In some embodiments, when the battle between the first pet character and the second pet character ends, the energy value possessed by the first pet character is increased, so that the energy value possessed by the first pet character reaches the upper limit of the energy value corresponding to the first pet character.

Third item: Increase the energy value possessed by the first pet character in response to the first pet character casting an energy recovery skill. In this embodiment of this application, the first pet character has an energy recovery skill. When the first pet character casts the energy recovery skill, the energy value possessed by the first pet character can be increased, so that the first pet character can also recover the energy value during the battle, thereby enriching the diversity of the battle, improving the interaction effect, and further improving the user experience. The energy recovery skill is a skill that can be cast at any time. For example, when the first pet character is displayed in the virtual world scene, the user can trigger the energy recovery skill through the terminal to increase the energy value possessed by the first pet character. The energy recovery skill is a skill that can be cast by the first pet character during the battle. If the energy recovery skill is a skill that can be cast by the first pet character during the battle, in the process of the turn-based battle, pet characters participating in the battle can only cast one skill in each turn. For example, in any turn, the pet character can cast one of an energy recovery skill, an attack skill, a defense skill, or a state updating skill. If the first pet character casts the energy recovery skill in the current turn, the attack skill, the defense skill, or the state updating skill cannot be cast in the current turn.

Fourth item: Increase the energy value possessed by the first pet character when the main control virtual character is located in a record storage area in the virtual world scene. In this embodiment of this application, the main control virtual character possesses the first pet character, the record storage area exists in the virtual world scene, and the record storage area is configured for storing a game progress. After the main control virtual character enters the record storage area, the game progress corresponding to the main control virtual character can be stored, and the energy value possessed by the pet character possessed by the main control virtual character can also be increased, thereby enriching the mode of increasing the energy value of the pet character in the game scene, and ensuring the user experience.

In this embodiment of this application, when the main control virtual character is located in the record storage area in the virtual world scene, the energy value possessed by the first pet character is increased. In another embodiment, when the main control virtual character is located in the record storage area in the virtual world scene, the energy value possessed by each pet character possessed by the main control virtual character is increased.

In this embodiment of this application, a countering relationship between skills is determined based on the skill type to which the skill belongs. In another embodiment, there is no need to perform operation 403 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2, the first skill in this embodiment of this application is an attack skill. For a specific process, refer to the following embodiment. FIG. 5 is a flowchart of a battle method according to an embodiment of this application. For example, the method is performed by a terminal. As shown in FIG. 5, the method includes the following:

501: A terminal displays a main control virtual character in a virtual world scene.

502: The terminal switches the virtual world scene to a battle scene in response to a trigger event of a turn-based battle, a first pet character and a second pet character being displayed in the battle scene, and the main control virtual character possessing the first pet character.

Operations 501 to 502 are similar to operations 301 to 302 mentioned above. Details are not described herein again.

503: The terminal controls the first pet character to cast an attack skill to the second pet character and controls the second pet character to cast a second skill when the attack skill overcomes the second skill to be cast by the second pet character in response to the attack skill of the first pet character being triggered, where an attribute weakening value caused by the attack skill to the second pet character is greater than a default attribute weakening value of the attack skill; or a number of attacks of the first pet character against the second pet character is higher than a default number of attacks of the attack skill.

In this embodiment of this application, the first skill is an attack skill. When the attack skill overcomes the second skill, the first pet character can be controlled to cast the attack skill to the second pet character to reflect a process of the first pet character attacking the second pet character, and the second pet character is controlled to cast the second skill. In addition, an attribute weakening value caused by the attack skill to the second pet character is greater than a default attribute weakening value of the attack skill; or a number of attacks of the first pet character against the second pet character is higher than a default number of attacks of the attack skill, reflecting a bonus effect of the attack skill. That is, the bonus effect improves the skill effect caused by the attack to ensure that the battle situation between the first pet character and the second pet character can reflect a countering relationship between skills, so that the user can intuitively sense an impact of the countering relationship between skills on the battle situation, thereby improving the interaction effect, and also improving the user experience.

The second skill is a skill countered by the attack skill. For example, the second skill is any state updating skill. The attack skill is configured for weakening an attribute of the attacked party according to the corresponding attribute weakening value. The attribute corresponding to the attribute weakening value is an attribute of any type. For example, if the attribute weakening value is the health point of the attacked party, the attribute weakening value is equivalent to a damage value, that is, the attack skill is configured for reducing the health point of the attacked party according to the corresponding damage value. The default attribute weakening value of the attack skill is a skill effect generated by the attack skill when the attack skill receives no bonus, that is, a value of weakening the attribute of the attacked party when the attack skill receives no bonus. The attribute weakening value caused by the attack skill to the second pet character is higher than the default attribute weakening value of the attack skill, indicating that the attribute weakening value corresponding to the attack skill is enhanced when the attack skill is cast with a bonus effect. The default number of attacks of the attack skill refers to a skill effect generated by the attack skill when the attack skill receives no bonus, that is, a number of times that the first pet character can attack the second pet character when the first pet character casts the attack skill when the attack skill receives no bonus. The number of attacks of the first pet character against the second pet character is higher than the default number of attacks of the attack skill, indicating that the number of attacks corresponding to the attack skill is enhanced when the attack skill is cast with a bonus effect.

For example, the default attribute weakening value of the attack skill indicates “causing a damage by 50 to the attacked party”. When the attack skill overcomes the second skill to be cast by the second pet character, after the first pet character is controlled to cast the attack skill to the second pet character, the attribute weakening value caused by the attack skill to the second pet character indicates “causing a damage by 300 to the attacked party”. For another example, the default number of attacks of the attack skill is 1. When the attack skill overcomes the second skill to be cast by the second pet character, after the first pet character is controlled to cast the attack skill to the second pet character, the number of attacks of the first pet character against the second pet character is 3.

This embodiment of this application is described by taking an example in which the first skill is an attack skill. In another embodiment, there is no need to perform operation 503 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

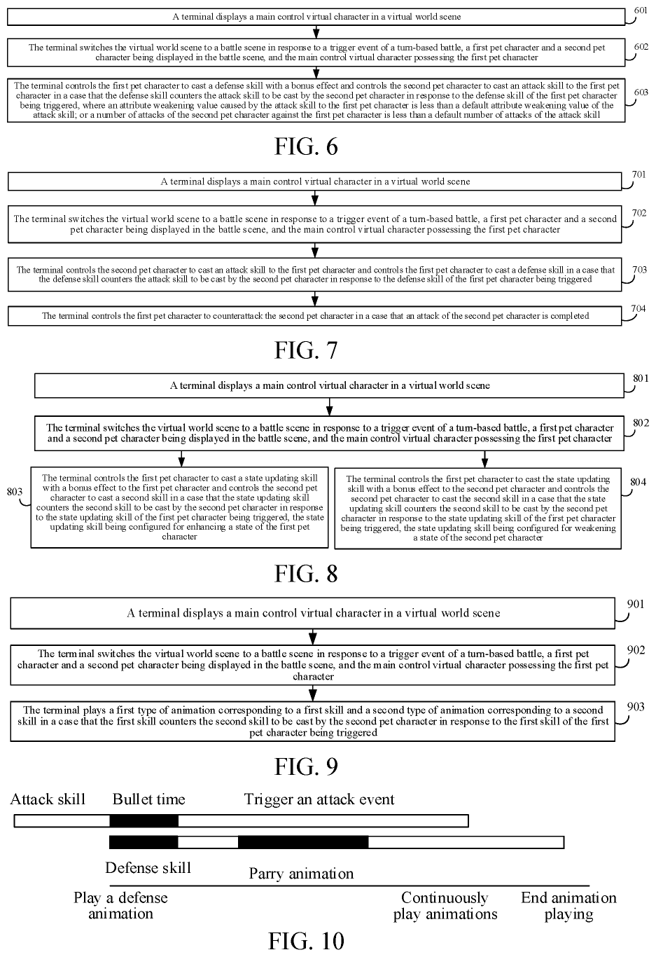

Based on the embodiment shown in FIG. 2, in this embodiment of this application, the first skill is a defense skill, and the second skill is an attack skill. For a specific process, refer to the following embodiment. FIG. 6 is a flowchart of a battle method according to an embodiment of this application. For example, the method is performed by a terminal. As shown in FIG. 6, the method includes the following:

601: A terminal displays a main control virtual character in a virtual world scene.

602: The terminal switches the virtual world scene to a battle scene in response to a trigger event of a turn-based battle, a first pet character and a second pet character being displayed in the battle scene, and the main control virtual character possessing the first pet character.

Operations 601 to 602 are similar to operations 301 to 302 mentioned above. Details are not described herein again.

603: The terminal controls the first pet character to cast a defense skill with a bonus effect and controls the second pet character to cast an attack skill to the first pet character when the defense skill overcomes the attack skill to be cast by the second pet character in response to the defense skill of the first pet character being triggered, where an attribute weakening value caused by the attack skill to the first pet character is less than a default attribute weakening value of the attack skill; or a number of attacks of the second pet character against the first pet character is less than a default number of attacks of the attack skill.

In this embodiment of this application, the first skill is a defense skill, and the second skill is an attack skill. When the defense skill overcomes the attack skill, the first pet character is controlled to cast the defense skill with a bonus effect, and the second pet character is controlled to cast the attack skill to the first pet character, so as to reflect a process of the second pet character attacking the first pet character. In addition, an attribute weakening value caused by the attack skill to the first pet character is less than a default attribute weakening value of the attack skill; or a number of attacks of the first pet character against the second pet character is less than a default number of attacks of the attack skill, reflecting a bonus effect of the defense skill. That is, the bonus effect of the defense skill weakens the attack skill of the opposite party to ensure that the battle situation between the first pet character and the second pet character can reflect a countering relationship between skills, so that the user can intuitively sense an impact of the countering relationship between skills on the battle situation, thereby improving the interaction effect, and also improving the user experience.

Operation 603 is similar to operation 503 mentioned above. Details are not described herein again. This embodiment of this application is described by taking an example in which the first skill is a defense skill, and the second skill is an attack skill. In another embodiment, there is no need to perform operation 603 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2, in this embodiment of this application, the first skill is a defense skill, and the second skill is an attack skill. For a specific process, refer to the following embodiment. FIG. 7 is a flowchart of a battle method according to an embodiment of this application. For example, the method is performed by a terminal. As shown in FIG. 7, the method includes the following:

701: A terminal displays a main control virtual character in a virtual world scene.

702: The terminal switches the virtual world scene to a battle scene in response to a trigger event of a turn-based battle, a first pet character and a second pet character being displayed in the battle scene, and the main control virtual character possessing the first pet character.

703: The terminal controls the second pet character to cast an attack skill to the first pet character and controls the first pet character to cast a defense skill when the defense skill overcomes the attack skill to be cast by the second pet character in response to the defense skill of the first pet character being triggered.

Operations 701 to 703 are similar to operations 301 to 303 mentioned above. Details are not described herein again.

704: The terminal controls the first pet character to counterattack the second pet character when an attack of the second pet character is completed.

When an attack of the second pet character is completed, controlling the first pet character to counterattack the second pet character is equivalent to controlling the first pet character to cast the defense skill with a bonus effect, that is, the bonus effect of the defense skill is to counterattack the attacking party. For example, if the default attribute of the defense skill is to reduce a damage value by 80%, during the battle, the first pet character is controlled to cast the defense skill, the second pet character is controlled to cast the attack skill to the first pet character, and the damage value caused by the attack skill to the first pet character is reduced by 80%. In addition, when the attack of the second pet character is completed, the first pet character is controlled to counterattack the second pet character to reflect a bonus effect caused by the defense skill overcoming the attack skill.

In this embodiment of this application, when the defense skill overcomes the attack skill to be cast by the second pet character, the second pet character is controlled to cast the attack skill to the first pet character, and the first pet character is controlled to cast the defense skill. Then, when the attack of the second pet character is completed, the first pet character is controlled to counterattack the second pet character, reflecting that the bonus effect of the defense skill is to counterattack the attacking party, so as to ensure that the battle situation between the first pet character and the second pet character can reflect a countering relationship between the skills, so that the user can intuitively sense an impact of the countering relationship between skills on the battle situation, thereby improving the interaction effect, and also improving the user experience; and different skill effects can be achieved without the need to perform excessive operations by the user, thereby improving the human-computer interaction efficiency.

This embodiment of this application is described by taking an example in which the first skill is a defense skill, and the second skill is an attack skill. In another embodiment, there is no need to perform operations 703 to 704 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2, the first skill in this embodiment of this application is a state updating skill. For a specific process, refer to the following embodiment. FIG. 8 is a flowchart of a battle method according to an embodiment of this application. For example, the method is performed by a terminal. As shown in FIG. 8, the method includes the following:

801: A terminal displays a main control virtual character in a virtual world scene.

802: The terminal switches the virtual world scene to a battle scene in response to a trigger event of a turn-based battle, a first pet character and a second pet character being displayed in the battle scene, and the main control virtual character possessing the first pet character.

Operations 801 to 802 are similar to operations 301 to 302 mentioned above. Details are not described herein again.

803: The terminal controls the first pet character to cast a state updating skill with a bonus effect to the first pet character and controls the second pet character to cast a second skill when the state updating skill overcomes the second skill to be cast by the second pet character in response to the state updating skill of the first pet character being triggered, the state updating skill being configured for enhancing a state of the first pet character.

In this embodiment of this application, the state updating skill of the first pet character may be configured for enhancing the state of the first pet character or weakening the state of another pet character. When the first pet character casts the state updating skill to the first pet character, the state of the first pet character is enhanced with a bonus effect; and when the first pet character casts the state updating skill to the second pet character, the state of the second pet character is weakened with a bonus effect, thereby enriching an interaction mode between the pet characters, also enriching the skill effect of the skill, improving the interaction effect between the pet characters, enhancing the strategy of the game, and further improving the user experience. The second skill is a skill countered by the state updating skill. For example, the second skill is a defense skill. States to be updated by the state updating skill include the physical defense, magic defense and health point of the pet character, the cooling duration of the skill, and the like. That is, when the first pet character is controlled to cast the state updating skill with a bonus effect to the first pet character, the physical defense of the first pet character is enhanced, the magic defense of the first pet character is enhanced, the health point of the first pet character is increased, or the cooling duration of the skill of the first pet character is reduced. For example, the default effect of the state updating skill is “recovering 30% of the health point”. When the first pet character is controlled to cast the state updating skill with a bonus effect to the first pet character, 90% of the health point is recovered for the first pet character.

804: The terminal controls the first pet character to cast the state updating skill with a bonus effect to the second pet character and controls the second pet character to cast the second skill when the state updating skill overcomes the second skill to be cast by the second pet character in response to the state updating skill of the first pet character being triggered, the state updating skill being configured for weakening a state of the second pet character.

In this embodiment of this application, when the first pet character is controlled to cast the state updating skill with a bonus effect to the second pet character, the physical defense of the second pet character is weakened, the magic defense of the second pet character is weakened, the health point of the second pet character is weakened, or the cooling duration of the skill of the second pet character is increased. For example, the default effect of the state updating skill is “reducing the attack speed of the opposite party by 50%”. When the first pet character is controlled to cast the state updating skill with a bonus effect to the second pet character, the attack speed of the second pet character is reduced by 150%.

In a implementation, a same state updating skill corresponds to two types of skill effects. One type of skill effect is a skill effect when the state updating skill is cast to itself, and the other type of skill effect is a skill effect when the state updating skill is cast to the opposite party. In addition, each type of skill effect includes two skill effects. For the two skill effects included in the same type of skill effect, one skill effect is a default effect of the state updating skill, and the other skill effect is a bonus effect of the state updating skill. For example, the description of the skill effect of the state updating skill is “recovering 30% of the health point of itself when the state updating skill is cast to itself, recovering 80% of the health point of itself when the state updating skill is cast to itself and counters the skill of the opposite party, reducing 30% of the health point of the opposite party when the state updating skill is cast to the opposite party, and reducing 80% of the health point of the opposite party when the state updating skill is cast to the opposite party and counters the skill of the opposite party”, where “recovering 30% of the health point of itself when the state updating skill is cast to itself” is equivalent to the default effect when the state updating skill is cast to itself, “recovering 80% of the health point of itself when the state updating skill is cast to itself and counters the skill of the opposite party” is equivalent to the bonus effect when the state updating skill is cast to itself, “reducing 30% of the health point of the opposite party when the state updating skill is cast to the opposite party” is equivalent to the default effect when the state updating skill is cast to the opposite party, and “reducing 80% of the health point of the opposite party when the state updating skill is cast to the opposite party and counters the skill of the opposite party” is equivalent to the bonus effect when the state updating skill is cast to the opposite party.

This embodiment of this application is described by taking an example in which the first skill is a state updating skill. In another embodiment, there is no need to perform operations 803 to 804 mentioned above, but another mode is used, including: control the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiment shown in FIG. 2 above, in this embodiment of this application, a process of controlling a pet character to cast a skill is reflected in a mode of playing an animation. For a specific process, refer to the following embodiment. FIG. 9 is a flowchart of a battle method according to an embodiment of this application. For example, the method is performed by a terminal. As shown in FIG. 9, the method includes the following:

901: A terminal displays a main control virtual character in a virtual world scene.

902: The terminal switches the virtual world scene to a battle scene in response to a trigger event of a turn-based battle, a first pet character and a second pet character being displayed in the battle scene, and the main control virtual character possessing the first pet character.

Operations 901 to 902 are similar to operations 301 to 302 mentioned above. Details are not described herein again.

903: The terminal plays a first type of animation corresponding to a first skill and a second type of animation corresponding to a second skill when the first skill overcomes the second skill to be cast by the second pet character after the casting of the first skill by the first pet character being triggered.

In this embodiment of this application, the first skill corresponds to a first type of animation and a second type of animation, and the second skill corresponds to a first type of animation and a second type of animation; the first type of animation corresponding to the first skill is configured for displaying a picture of the first pet character casting the first skill with a bonus effect, and the second type of animation corresponding to the first skill is configured for displaying a picture of the first pet character casting the first skill; and the first type of animation corresponding to the second skill is configured for displaying a picture of the second pet character casting the second skill with a bonus effect, and the second type of animation corresponding to the second skill is configured for displaying a picture of the second pet character casting the second skill. That is, two types of animations corresponding to one skill respectively represent pictures of casting skills in different cases. When the first pet character casts the first skill and the second pet character casts the second skill, animations of corresponding types are played according to a countering relationship between the first skill and the second skill, so as to reflect different skill effects generated when the same skill overcomes the skill of the opposite party or does not counter the skill of the opposite party, thereby improving the interaction effect. When the user selects the skill to be cast for the pet character through the terminal, the user cannot learn the skill effect generated by the skill and can only learn the skill effect generated by the skill when the battle starts, and the skill effect is displayed in an animation mode, thereby ensuring the display effect of the picture in the battle process, improving the fun of the game, and further improving the user experience.

For example, the first skill is a state updating skill, the second type of animation corresponding to the state updating skill is configured for displaying a picture of the first pet character casting the state updating skill to weaken the state of the opposite pet character, and the first type of animation corresponding to the state updating skill is configured for displaying a picture of the first pet character casting the state updating skill to weaken the state of the opposite pet character and a picture of enhancing the state of the first pet character. For example, the first skill is an attack skill, the second type of animation corresponding to the attack skill is configured for displaying a picture of the first pet character casting the attack skill to the opposite pet character to reduce the health point of the opposite pet character, and the first type of animation corresponding to the attack skill is configured for displaying a picture of the first pet character casting the attack skill to the opposite pet character to reduce the health point of the opposite pet character, and also displaying a picture of continuously attacking the opposite pet character.

In some embodiments, the first type of animation or the second type of animation of each skill can display an impact generated after the skill is cast. For example, taking an attack skill as an example, the first type of animation or the second type of animation of the attack skill can reflect a damage caused by the attack skill.

In a implementation, operation 903 includes: playing the second type of animation corresponding to the second skill when the first skill overcomes the second skill after the casting of the first skill by the first pet character being triggered; and playing the first type of animation corresponding to the first skill in response to a preset event being triggered in the process of playing the second type of animation corresponding to the second skill, the preset event indicating an interaction state between the second pet character and the first pet character or a playing duration of the second type of animation corresponding to the second skill.

In this embodiment of this application, when the first pet character is about to cast the first skill and the second pet character is about to cast the second skill, because the first skill overcomes the second skill, the second type of animation corresponding to the second skill is first played to reflect a picture of the second pet character casting the second skill; and then, in response to the preset event being triggered, the first type of animation corresponding to the first skill is played to reflect a picture of controlling the first pet character to cast the second skill with a bonus effect. In this way, the situation that the first pet character casts the second skill with a bonus effect can be highlighted, so that the user can learn which skill is countered by viewing the displayed picture; and a countering situation between two skills can also be reflected, thereby ensuring the control accuracy and the interaction effect between pet characters.

The foregoing process of first playing the second type of animation corresponding to the second skill and then playing the first type of animation corresponding to the first skill is similar to operations 303 to 304 mentioned above, and details are not described herein again.

In some embodiments, the first skill is a defense skill, and the second skill is an attack skill. The process of playing the first type of animation corresponding to the first skill includes: playing the first type of animation corresponding to the first skill when the second pet character is about to attack the first pet character; and playing an animation of attack parry of the first pet character in the process of the second pet character attacking the first pet character.

In this embodiment of this application, that the second pet character is about to attack the first pet character is equivalent to that the preset event is triggered. When the second pet character is about to attack the first pet character, the first type of animation corresponding to the first skill is played; and in the process of the second pet character attacking the first pet character, an animation of attack parry of the first pet character is played, so as to reflect a picture of an attack of the first pet character casting the defense skill to attack the second pet character, thereby enriching the display effect of the battle process, and improving the user experience.

The second type of animation corresponding to the attack skill can reflect a picture of the second pet character attacking the first pet character, and the first type of animation corresponding to the defense skill can reflect a picture of the first pet character casting the defense skill and a bonus effect. The animation of attack parry of the first pet character can reflect a picture of the first pet character casting the defense skill to parry the attack of the second pet character.

In some embodiments, the process of playing the first type of animation corresponding to the first skill includes: pausing a playing of the second type of animation corresponding to the attack skill and playing the first type of animation corresponding to the defense skill when the second pet character is about to attack the first pet character in the process of playing the second type of animation corresponding to the attack skill, and continuing to play the second type of animation corresponding to the attack skill when the first type of animation corresponding to the defense skill indicates that the first pet character completes a cast of the defense skill; or reducing a playing speed of the second type of animation corresponding to the attack skill and playing the first type of animation corresponding to the defense skill when the second pet character is about to attack the first pet character in the process of playing the second type of animation corresponding to the attack skill, and recovering the playing speed of the second type of animation corresponding to the attack skill when the first type of animation indicates that the first pet character completes the cast of the defense skill.

In this embodiment of this application, the first type of animation corresponding to the defense skill is configured for displaying a picture of the first pet character casting the defense skill so that the first pet character is in a defense state, and the first pet character remains in the defense state after the cast of the defense skill is completed. When the second type of animation corresponding to the attack skill indicates that the second pet character is about to attack the first pet character, the second type of animation corresponding to the attack skill is played in a mode of pausing playing or decelerating playing; and when the first type of animation corresponding to the defense skill indicates that the first pet character completes the cast of the defense skill, the playing of the second type of animation corresponding to the attack skill is recovered, so that the situation that the first pet character and the second pet character respectively cast skills to battle against each other can be reflected, the interaction effect between the first pet character and the second pet character is enhanced, and the display effect of the animation can be improved.

For example, when the first pet character casts the defense skill and the second pet character casts the attack skill, the process of playing an animation by the terminal is shown in FIG. 10. The second type of animation corresponding to the attack skill of the second pet character is first played. In the process of playing the second type of animation corresponding to the attack skill, if the second type of animation corresponding to the attack skill displays that the second pet character is about to attack the first pet character, the second type of animation corresponding to the attack skill is played in a mode of pausing playing or decelerating playing, and the first type of animation corresponding to the defense skill of the first pet character is inserted. For example, at this time, a blue flashing special effect is displayed on the first pet character, the background of the battle scene is darkened, the time of the battle scene is slowed down, and the defense special effect animation is played accordingly. When the first type of animation corresponding to the defense skill indicates that the first pet character completes the cast of the defense skill, the second type of animation corresponding to the attack skill of the second pet character is played continuously or the playing speed of the second type of animation corresponding to the attack skill is recovered; then, an attack stage (that is, bullet time) is performed, the second type of animation corresponding to the attack skill of the second pet character and the first type of animation corresponding to the defense skill of the first pet character are played continuously, which is equivalent to triggering an attack event of the second pet character against the first pet character to reflect that the second pet character casts the attack skill to the first pet character; and the first pet character casts the defense skill, and the animation of attack parry of the first pet character is played to reflect a picture of the first pet character casting the defense skill to parry the attack of the second pet character. In the continuous attack process of the second pet character, a picture of the first pet character remaining in the defense state and presenting parry of the attack of the second pet character is presented, and this process is a special effect continuous stage. When the second type of animation corresponding to the attack skill of the first pet character ends, the playing of the second type of animation corresponding to the attack skill of the first pet character, the first type of animation corresponding to the defense skill of the first pet character, and the picture of parrying the attack of the second pet character is canceled, that is, battle special effects are cleared. That is, for the terminal, the terminal can obtain animations at various stages during the battle, for example, the second type of animation corresponding to the attack skill of the second pet character, the first type of animation corresponding to the defense skill of the first pet character, and the animation of attack parry of the first pet character. According to trigger points of multiple preset events shown in FIG. 11, a corresponding animation can be played when a corresponding event is triggered, so as to ensure the display effect of a presented picture of a battle situation.

In some embodiments, the duration of the first type of animation corresponding to the first skill is less than the duration of the second type of animation corresponding to the second skill; and the process of playing the first type of animation corresponding to the first skill and the second type of animation corresponding to the second skill includes: repeatedly playing the first type of animation corresponding to the first skill if the playing of the first type of animation corresponding to the first skill ends in the process of playing the second type of animation corresponding to the second skill. In this embodiment of this application, because the duration of the first type of animation corresponding to the first skill is less than the duration of the second type of animation corresponding to the second skill, in the process of playing the animation, there is situation that the first type of animation corresponding to the first skill ends when the playing of the second type of animation corresponding to the second skill does not end. Then, a mode of repeatedly playing the first type of animation corresponding to the first skill is adopted to ensure that the first type of animation corresponding to the first skill can be played all the time in the process of playing the second type of animation corresponding to the second skill, reflecting an effect that two pet characters cast different skills for a battle, so that the battle process is more vivid, and the display effect is ensured, thereby improving the user experience.

In some embodiments, in the process of playing the first type of animation corresponding to the first skill and the second type of animation corresponding to the second skill, if the second type of animation corresponding to the second skill ends, the playing of the first type of animation corresponding to the first skill is stopped. In this embodiment of this application, because the duration of the first type of animation corresponding to the first skill is less than the duration of the second type of animation corresponding to the second skill, in the process of playing the second type of animation corresponding to the second skill, if the playing of the first type of animation corresponding to the first skill ends, the first type of animation corresponding to the first skill is repeatedly played; and if the second type of animation corresponding to the second skill ends, the playing of the first type of animation corresponding to the first skill is stopped to indicate that the current battle between two pet characters ends. In this embodiment of this application, the first skill is a defense skill, and the second skill is an attack skill. The first type of animation corresponding to the defense skill is a defense skill special effect, and the defense skill special effect is a Loop special effect. The first type of animation corresponding to the defense skill ends only when the playing of the second type of animation corresponding to the attack skill ends, so as to adapt to the second type of animation corresponding to attack skills of different durations.

This embodiment of this application is described by taking an example in which a process of controlling a pet character to cast a skill is reflected in a mode of playing an animation. In another embodiment, there is no need to perform operation 903 mentioned above, but another mode is used, including: controlling the first pet character to cast the first skill with a bonus effect and control the second pet character to cast the second skill when the first skill overcomes the second skill to be cast by the second pet character after the casting of the first skill by the first pet character being triggered.

In the solutions provided in the embodiments of this application, when a virtual world scene is displayed, in response to a trigger event of a turn-based battle, the virtual world scene is switched to a battle scene, and pet characters participating in a battle are displayed in the battle scene. In the battle scene, the pet characters participating in the battle can all cast skills to battle, and there may be a countering relationship between different skills. When the first skill to be cast by the first pet character counters the second skill to be cast by the second pet character, the first pet character is controlled to cast the first skill with a bonus effect, and the second pet character is controlled to cast the second skill, thereby implementing a new battle mode. When two pet characters performing a battle respectively cast skills, an effect bonus is applied, with reference to a countering relationship between the cast skills, to a skill that counters a skill cast by the opposite party, so that a diversity of battle results can be ensured, and an interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

Based on the embodiments shown in FIG. 2 to FIG. 11 above, in this embodiment of this application, at least one of the following modes can further be adopted to control the first pet character to cast the first skill with a bonus effect.

First mode: The first pet character is controlled to cast the first skill with a default effect, and an energy value possessed by the second pet character is reduced, the energy value being configured for casting a skill. In this embodiment of this application, reducing the energy value possessed by the second pet character is equivalent to a bonus effect brought when the first skill overcomes the second skill.

For example, the first skill is an attack skill, the second skill is a state updating skill, and a bonus effect of the attack skill is “causing a physical damage to the opposite party, and the enemy loses two energy values”, where “causing a physical damage to the opposite party” is a default effect of the attack skill. For example, the first skill is a state updating skill, the second skill is a defense skill, and a bonus effect of the state updating skill is “increasing the own energy value by 4, and reducing the energy value of the enemy by 4”, where “increasing the own energy value by 4” is a default effect of the state updating skill. For example, the first skill is a state updating skill, the second skill is a defense skill, a bonus effect of the state updating skill is “reducing the energy value of the enemy by 8”, and a default effect of the state updating skill is “reducing the energy value of the enemy by 4”. For example, the first skill is a defense skill, the second skill is an attack skill, and a bonus effect of the defense skill is “reducing this damage by 80%, and reducing the energy value of the enemy by 4”, where “reducing this damage by 80%” is a default effect of the defense skill.

Second mode: The first pet character is controlled to cast the first skill with a default effect, and an energy value possessed by the first pet character is increased. In this embodiment of this application, increasing the energy value possessed by the first pet character is equivalent to a bonus effect brought when the first skill overcomes the second skill.

For example, the first skill is an attack skill, the second skill is a state updating skill, and a bonus effect of the attack skill is “causing a physical damage to the opposite party, interrupting the skill of the opposite party, and obtaining an energy value consumed when the interrupted skill is cast”, where “causing a physical damage to the opposite party” is a default effect of the attack skill. For example, the first skill is a defense skill, the second skill is an attack skill, and a bonus effect of the defense skill is “reducing this damage by 70%, and increasing the own energy value by 5”, where “reducing this damage by 70%” is a default effect of the defense skill.

Third mode: The first pet character is controlled to cast the first skill with a default effect, and the second pet character is controlled to suspend the cast of the second skill. In this embodiment of this application, suspending the cast of the second skill is equivalent to a bonus effect brought when the first skill overcomes the second skill.

For example, the first skill is an attack skill, the second skill is a state updating skill, and a bonus effect of the attack skill is “causing a magic damage to the opposite party, and interrupting the skill of the opposite party”, where “causing a magic damage to the opposite party” is a default effect of the attack skill. For example, the first skill is an attack skill, the second skill is a state updating skill, and a bonus effect of the attack skill is “causing a physical damage to the opposite party, and interrupting the skill of the opposite party”, where “causing a physical damage to the opposite party” is a default effect of the attack skill. For example, the first skill is a defense skill, the second skill is an attack skill, and a bonus effect of the defense skill is “standby, interrupting the skill of the opposite party, and causing a physical damage by 80”, where “standby” is a default effect of the defense skill.

Fourth mode: The first pet character is controlled to cast the first skill with a default effect, and an attribute value of the second pet character is reduced. The attribute value includes the physical defense, attack speed, magic defense, blood sucking ratio, health point, and the like of the pet character. In this embodiment of this application, reducing the attribute value of the second pet character is equivalent to a bonus effect brought when the first skill overcomes the second skill.

For example, the first skill is a state updating skill, the second skill is a defense skill, a bonus effect of the state updating skill is “reducing the speed of the opposite party by 150%”, and a default effect of the state updating skill is “reducing the speed of the enemy by 50%”. For example, the first skill is an attack skill, the second skill is a state updating skill, a bonus effect of the attack skill is “causing a physical damage to the opposite party, and reducing the physical defense of the enemy by 80%”, and a default effect of the attack skill is “causing a physical damage to the opposite party”. For example, the first skill is a defense skill, the second skill is an attack skill, a bonus effect of the defense skill is “reducing the damage by 80%, and reducing the physical attack of the enemy by 50%”, and a default effect of the defense skill is “reducing the damage by 80%”.

In a implementation, the fourth mode includes: controlling the first pet character to cast the first skill with a default effect, and displaying that the second pet character is in a weakened state and the attribute value of the second pet character gradually decreases. In this embodiment of this application, the second pet character being in a weakened state and the attribute value of the second pet character gradually decreasing is equivalent to a bonus effect brought when the first skill overcomes the second skill. That is, when the first skill cast by the first pet character counters the second skill cast by the second pet character, in addition to the default effect of the first skill, an additional weakened state is further added to the second pet character, so that the attribute value of the second pet character continuously decreases, thereby enriching the skill effect of the skill, and improving the interaction effect between pet characters.

The weakened state refers to an abnormal state. When the pet character is in the weakened state, the attribute value gradually decreases. For example, the weakened state is a poisoned state, a frozen state, a burned state, or the like. For example, the first skill is an attack skill, the second skill is a state updating skill, a bonus effect of the attack skill is “causing a physical damage to the opposite party, endowing the opposite party with one level of poisoning effect, and endowing the opposite party with three levels of poisoning effect when the second skill is countered”, a default effect of the attack skill is “causing a physical damage to the opposite party, and endowing one level of poisoning”, and the health point of the second pet character gradually decreases when the second pet character has at least one level of poisoning effect. For example, the first skill is a state updating skill, the second skill is a defense skill, a bonus effect of the state updating skill is “endowing the enemy with six levels of burning effect, and endowing the enemy with eighteen levels of burning effect when the second skill is countered”, a default effect of the state updating skill is “endowing the enemy with six levels of burning effect”, and the health point of the second pet character gradually decreases when the second pet character has a burning effect. For example, the first skill is a state updating skill, the second skill is a defense skill, a bonus effect of the state updating skill is “endowing the enemy with two levels of poisoning effect, and endowing the enemy with six levels of poisoning effect when the second skill is countered”, a default effect of the state updating skill is “endowing the enemy with two levels of poisoning effect”, and the health point of the second pet character gradually decreases when the second pet character has a poisoning effect. For example, the first skill is a defense skill, the second skill is an attack skill, a bonus effect of the defense skill is “reducing this damage by 70%, and endowing the enemy with six levels of burning effect”, and a default effect of the defense skill is “reducing this damage by 70%”. For example, the first skill is a defense skill, the second skill is an attack skill, a bonus effect of the defense skill is “reducing this damage by 80%, and endowing the enemy with three levels of freezing effect”, a default effect of the defense skill is “reducing this damage by 80%”, and the health point of the second pet character gradually decreases when the second pet character has a freezing effect.

Fifth mode: The first pet character is controlled to cast the first skill with a default effect, and an attribute value of the first pet character is increased. In this embodiment of this application, increasing the attribute value of the first pet character is equivalent to a bonus effect brought when the first skill overcomes the second skill.

For example, the first skill is an attack skill, the second skill is a state updating skill, a bonus effect of the attack skill is “causing a physical damage to the opposite party, and increasing the own physical attack by 20%”, and a default effect of the attack skill is “causing a physical damage to the opposite party”. For example, the first skill is an attack skill, the second skill is a state updating skill, a bonus effect of the attack skill is “accumulating power, causing a physical damage to the opposite party, and increasing the own physical attack by 100%”, and a default effect of the attack skill is “accumulating power, and causing a physical damage to the opposite party”. For example, the first skill is an attack skill, the second skill is a state updating skill, a bonus effect of the attack skill is “causing a physical damage to the opposite party, and sucking blood by 100%”, and a default effect of the attack skill is “causing a physical damage to the opposite party”. For example, the first skill is a state updating skill, the second skill is a defense skill, a bonus effect of the state updating skill is “increasing the speed by 50%, and increasing the physical attack by 80%”, and a default effect of the state updating skill is “increasing the speed by 50%”. For example, the first skill is a state updating skill, the second skill is a defense skill, a bonus effect of the state updating skill is “recovering 90% of the health point”, and a default effect of the state updating skill is “recovering 30% of the health point”. For example, the first skill is a state updating skill, the second skill is a defense skill, a bonus effect of the state updating skill is “reducing the physical defense and magic defense of the enemy by 40%, and increasing the own physical attack by 50%”, and a default effect of the state updating skill is “reducing the physical defense and magic defense of the enemy by 40%”. For example, the first skill is a defense skill, the second skill is an attack skill, a bonus effect of the defense skill is “reducing this damage by 70%, and increasing the own attack by 40%”, and a default effect of the defense skill is “reducing this damage by 70%”. For example, the first skill is a defense skill, the second skill is an attack skill, a bonus effect of the defense skill is “reducing this damage by 80%, and increasing the speed by 50%”, and a default effect of the defense skill is “reducing this damage by 80%”. For example, the first skill is a defense skill, the second skill is an attack skill, a bonus effect of the defense skill is “changing this damage to a recovered health point”, and a default effect of the defense skill is null. For example, the first skill is a defense skill, the second skill is an attack skill, a bonus effect of the defense skill is “reducing this damage by 70%, and recovering 25% of the own health point”, and a default effect of the defense skill is “reducing this damage by 70%”. For example, the first skill is a defense skill, the second skill is an attack skill, a bonus effect of the defense skill is “reducing this damage by 70%, and increasing the own magic attack by 40%”, and a default effect of the defense skill is “reducing this damage by 70%”. For example, the first skill is a defense skill, the second skill is an attack skill, a bonus effect of the defense skill is “reducing this damage by 80%, and sucking blood by 50%”, and a default effect of the defense skill is “reducing this damage by 80%”.

In a implementation, the fifth mode includes: controlling the first pet character to cast the first skill with a default effect, and displaying that the first pet character is in a gain state and the attribute value of the first pet character gradually increases. In this embodiment of this application, the first pet character being in a gain state and the attribute value of the first pet character gradually increasing is equivalent to a bonus effect brought when the first skill overcomes the second skill. That is, when the first skill cast by the first pet character counters the second skill cast by the second pet character, in addition to the default effect of the first skill, an additional gain state is further added to the first pet character, so that the attribute value of the first pet character gradually increases, thereby enriching the skill effect of the skill, and improving the interaction effect between pet characters.

When the pet character is in the gain state, the attribute value gradually increases. For example, the gain state is a blood return state, a blood sucking state, or the like. For example, the first skill is a state updating skill, the second skill is a defense skill, a bonus effect of the state updating skill is “endowing one level, and endowing three levels when the second skill is countered”, and a default effect of the state updating skill is “endowing one level”.

Sixth mode: The first pet character is controlled to cast the first skill with a default effect, and an energy value consumed when the skill of the first pet character is cast is reduced. In this embodiment of this application, reducing the energy value consumed when the skill of the first pet character is cast is equivalent to a bonus effect brought when the first skill overcomes the second skill.

The skill for reducing the consumed energy value is a skill cast by the first pet character in this turn, or is another skill of the first pet character. For example, the energy value consumed when the first skill of the first pet character is cast is reduced. For the mode of reducing the energy value consumed when the skill of the first pet character is cast, the energy value consumed when the skill of the first pet character is cast in a preset number of turns later is reduced, or the energy value consumed by the skill cast by the first pet character in this turn is reduced in this turn. The preset number is any number, for example, the preset number is 2, 3, or the like.

For example, the first skill is an attack skill, the second skill is a state updating skill, a bonus effect of the attack skill is “causing a physical damage, and reducing the energy value consumed by this skill by 4”, and a default effect of the attack skill is “causing a physical damage”. For example, the first skill is an attack skill, the second skill is a state updating skill, a bonus effect of the attack skill is “causing a magic damage, and reducing the energy value consumed by this skill by 6”, and a default effect of the attack skill is “causing a physical damage”. For example, the first skill is a defense skill, the second skill is an attack skill, a bonus effect of the defense skill is “reducing this damage by 70%, and reducing the energy value consumed by this skill by 1”, and a default effect of the defense skill is “reducing this damage by 70%”. For example, the first skill is a defense skill, the second skill is an attack skill, a bonus effect of the defense skill is “reducing this damage by 70%, and reducing the energy value consumed by this skill by 1”, and a default effect of the defense skill is “reducing this damage by 70%”. For example, the first skill is a defense skill, the second skill is an attack skill, a bonus effect of the defense skill is “reducing this damage by 90%, returning, and reducing the energy value consumed by this skill in each turn by 1”, and a default effect of the defense skill is “reducing this damage by 90%, and returning”.

Seventh mode: The first pet character is controlled to cast the first skill with a default effect, and an energy value consumed when the skill of the second pet character is cast is increased. In this embodiment of this application, increasing the energy value consumed when the skill of the second pet character is cast is equivalent to a bonus effect brought when the first skill overcomes the second skill. The skill for increasing the consumed energy value is a skill cast by the second pet character in this turn, or is another skill of the second pet character. For example, the energy value consumed when the second skill of the second pet character is cast is increased. For the mode of increasing the energy value consumed when the skill of the second pet character is cast, the energy value consumed when the skill of the second pet character is cast in a preset number of turns later is increased, or the energy value consumed by the skill cast by the second pet character in this turn is increased in this turn.

For example, the first skill is a defense skill, the second skill is an attack skill, a bonus effect of the defense skill is “reducing this damage by 70%, and increasing the energy value consumed by the skill cast by the enemy by 2”, and a default effect of the defense skill is “reducing this damage by 70%”. For example, the first skill is an attack skill, the second skill is a state updating skill, a bonus effect of the attack skill is “causing a physical damage, and increasing the energy value consumed by all skills of the enemy by 2”, and a default effect of the attack skill is “causing a physical damage”. For example, the first skill is a state updating skill, the second skill is a defense skill, a bonus effect of the state updating skill is “returning a backpack, and increasing the energy value consumed by the skill cast by the enemy by 8”, and a default effect of the state updating skill is “returning a backpack”. Returning a backpack means that the first pet character returns the packsack and another pet character possessed by the main control virtual character enters the field for a battle with the second pet character. For example, the first skill is a state updating skill, the second skill is a defense skill, a bonus effect of the state updating skill is “increasing the energy value consumed by the skill cast by the enemy in this turn by 4”, and a default effect of the state updating skill is “increasing the energy value consumed by the skill cast by the enemy in this turn by 2”.

Eighth mode: The first pet character is controlled to cast the first skill with a default effect, and a cooling duration of the skill of the first pet character is reduced. In this embodiment of this application, reducing the cooling duration of the skill of the first pet character is equivalent to a bonus effect brought when the first skill overcomes the second skill.

The cooling duration refers to a duration that needs to wait after the skill is cast until the skill can be cast next time. For example, the cooling duration is represented by the number of turns. For example, the cooling duration of a skill is three turns, that is, the skill can be cast every three turns. For example, the first skill is a defense skill, the second skill is an attack skill, a bonus effect of the defense skill is “reducing this damage by 90%, and reducing the number of cooling turns of this skill by 1”, and a default effect of the defense skill is “reducing this damage by 90%”.

Ninth mode: The first pet character is controlled to cast the first skill with a default effect, and a cooling duration of the skill of the second pet character is increased. In this embodiment of this application, increasing the cooling duration of the skill of the second pet character is equivalent to a bonus effect brought when the first skill overcomes the second skill.

For example, the first skill is a state updating skill, the second skill is a defense skill, a bonus effect of the state updating skill is “reducing the double defense of the enemy by 80%, and increasing the number of cooling turns of the countered skill by 2”, and a default effect of the state updating skill is “increasing the energy value consumed by the skill cast by the enemy in this turn by 2”.

Tenth mode: The first pet character is controlled to cast the first skill with a default effect when the first skill is not an object change skill, and the first pet character is switched to a third pet character when the interaction between the first pet character and the second pet character is completed, the third pet character and the first pet character being pet characters possessed by the same main control virtual character. In this embodiment of this application, the object change skill is configured for changing the current pet character. When the object change skill is triggered, the current pet character can be switched to another pet character possessed by the same main control virtual character. When the first skill is not the object change skill, switching the pet character is equivalent to a bonus effect brought when the first skill overcomes the second skill.

For example, the first skill is a defense skill, the second skill is an attack skill, a bonus effect of the defense skill is “reducing this damage by 80%, and returning a backpack”, and a default effect of the defense skill is “reducing this damage by 80%”. Returning a backpack means that the first pet character returns the packsack and another pet character possessed by the main control virtual character enters the field for a battle with the second pet character. For example, the first skill is a defense skill, the second skill is an attack skill, a bonus effect of the defense skill is “reducing this damage by 70%, and quickly returning to the field when responding”, and a default effect of the defense skill is “reducing this damage by 70%”.

Eleventh mode: The first pet character is controlled to cast the first skill with a default effect when the first pet character is in a weakened state, a unit amplitude corresponding to the weakened state is reduced, and an attribute value of the first pet character is gradually reduced according to the reduced unit amplitude. In this embodiment of this application, the weakened state is configured for gradually reducing the attribute value of the first pet character according to the corresponding unit amplitude, and reducing the unit amplitude corresponding to the weakened state is equivalent to a bonus effect brought when the first skill overcomes the second skill. After the first pet character is controlled to cast the first skill with a default effect, the unit amplitude corresponding to the weakened state is reduced, and it is displayed that the attribute value of the first pet character is gradually reduced according to the reduced unit amplitude.

In this embodiment of this application, when the first pet character does not cast the first skill, the first pet character is already in the weakened state. For example, the weakened state is a freezing effect, a poisoning effect, or the like. The unit amplitude corresponding to the weakened state refers to an amplitude of reducing the attribute value of the first pet character per unit time in the weakened state. For example, the weakened state is a poisoning effect, and the unit amplitude corresponding to the weakened state indicates a reduced health point of the first pet character per unit time when the first pet character is poisoned. After the first pet character is controlled to cast the first skill with a bonus effect, the weakened state of the first pet character may be weakened.

For example, the first skill is an attack skill, the second skill is a state updating skill, a bonus effect of the attack skill is “causing a magic damage, and weakening the freezing effect if there is a freezing effect”, and a default effect of the attack skill is “causing a magic damage”. For example, the first skill is an attack skill, the second skill is a state updating skill, a bonus effect of the attack skill is “causing a magic damage, and dispersing two own weakened states”, and a default effect of the attack skill is “causing a magic damage, and dispersing one own weakened state”. For example, the first skill is a defense skill, the second skill is an attack skill, a bonus effect of the defense skill is “reducing the damage by 70%, and erasing the targeted skill type”, and a default effect of the defense skill is “reducing the damage by 70%”.

Twelfth mode: The first pet character is controlled to cast the first skill with a default effect, and a difference between a first energy value and a second energy value is determined as an energy value consumed when the first skill is cast this time, the first energy value being an energy value consumed when the first skill is cast, and the second energy value being an energy value consumed when the second skill is cast. In this embodiment of this application, determining the difference between the first energy value and the second energy value as the energy value consumed when the first skill is cast this time is equivalent to a bonus effect brought when the first skill overcomes the second skill. For example, the first skill is a defense skill, the second skill is an attack skill, a bonus effect of the defense skill is “reducing this damage by 90%, and the energy value consumed by this skill is a difference between the energy values consumed by two skills”, and a default effect of the defense skill is “reducing this damage by 90%”.

Thirteenth mode: The first pet character is controlled to cast the first skill with a default effect in a current turn when the first pet character casts the skill of a preset skill type in the previous turn, and an energy value consumed when the first skill is cast in the current turn is reduced. In this embodiment of this application, reducing the energy value consumed when the first skill is cast in the current turn is equivalent to a bonus effect brought when the first skill overcomes the second skill.

For example, the first skill is a defense skill, the second skill is an attack skill, a bonus effect of the defense skill is “reducing the damage by 90%, and reducing the energy value consumed by this skill by 4 if the attack skill is cast last time”, and a default effect of the defense skill is “reducing the damage by 90%”.

Fourteenth mode: The first skill is an attack skill, the first pet character is controlled to cast the attack skill to itself with a default effect, the health point of the second pet character is controlled to be reduced, and the reduced health point of the second pet character is a damage value corresponding to the attack skill. In this embodiment of this application, the first pet character can cast an attack skill to itself to cause a damage to itself; if the attack skill overcomes the skill cast by the second pet character, the damage caused to itself is transferred to the second pet character, and the first pet character is no longer damaged; and if the attack skill does not counter the skill cast by the second pet character, the damage is only caused to itself.

In another implementation, the first skill is an attack skill. When the first skill overcomes the second skill, the first pet character is controlled to cast the attack skill to itself with a default effect, and the type resistance between skills can be offset. For example, the first skill belongs to a water-type skill, and the second pet character belongs to a soil-type pet character. When the first skill does not counter the second skill, when the first pet character casts the first skill to the second pet character, because the water type is countered by the soil type, the damage caused by the first skill is reduced; and when the first skill overcomes the second skill, it can be ignored that the water type is countered by the soil type, that is, the type resistance is offset, and the damage caused by the first skill to the second pet character is not reduced.

The foregoing multiple modes of controlling the first pet character to cast the first skill with a bonus effect can be randomly combined. Details are not described herein again in this application. In this embodiment of this application, in the process of controlling the first pet character to cast the first skill with a bonus effect, the bonus effect of the first skill can be reflected in one or more of multiple exemplary modes, so as to enrich the diversity of skill effects of skills cast in the battle process and provide multiple possibilities for the battle in each turn, so that the battle result is unstable, the fun of the game is improved, the interaction effect between pet characters can be enriched, the strategy of the game is enhanced, and the player can have better game experience.

The foregoing embodiment is described by taking an example in which the first skill overcomes the second skill. In another embodiment, when the second skill overcomes the first skill, the method further includes: controlling the first pet character to cast the first skill and controlling the second pet character to cast the second skill with a bonus effect when the second skill overcomes the first skill after the casting of the first skill by the first pet character being triggered. In this embodiment of this application, when the second skill overcomes the first skill, the first pet character is controlled to cast the first skill, and the second pet character is controlled to cast the second skill with a bonus effect. This process is similar to the process of controlling the first pet character to cast the first skill with a bonus effect and controlling the second pet character to cast the second skill in the foregoing embodiment, and details are not described herein again.

In this embodiment of this application, there may be a countering relationship between different skills. When the second skill to be cast by the second pet character counters the first skill to be cast by the first pet character, the first pet character is controlled to cast the first skill, and the second pet character is controlled to cast the second skill with a bonus effect, thereby implementing a new battle mode. When two pet characters performing a battle respectively cast skills, an effect bonus is applied, with reference to a countering relationship between the cast skills, to the skill that counters a skill cast by the opposite party, so that the diversity of battle results can be ensured, and the interaction effect between the pet characters can be improved. In addition, when selecting a skill to be cast for a pet character, a user not only needs to consider a skill effect of the skill, but also needs to consider a countering situation of a skill to be cast by the opposite pet character, so as to enhance the strategy of the game, and also improve the fun of the game, thereby improving the game experience. In addition, in a battle process, the effect bonus is applied to the skill that counters the skill cast by the opposite party, so that a battle progress can be accelerated, one of two battle parties can defeat the opposite party as soon as possible, and the turn-based battle can be ended without performing excessive turns. In this case, the user can end the turn-based battle without triggering excessive operations, thereby improving a human-computer interaction efficiency.

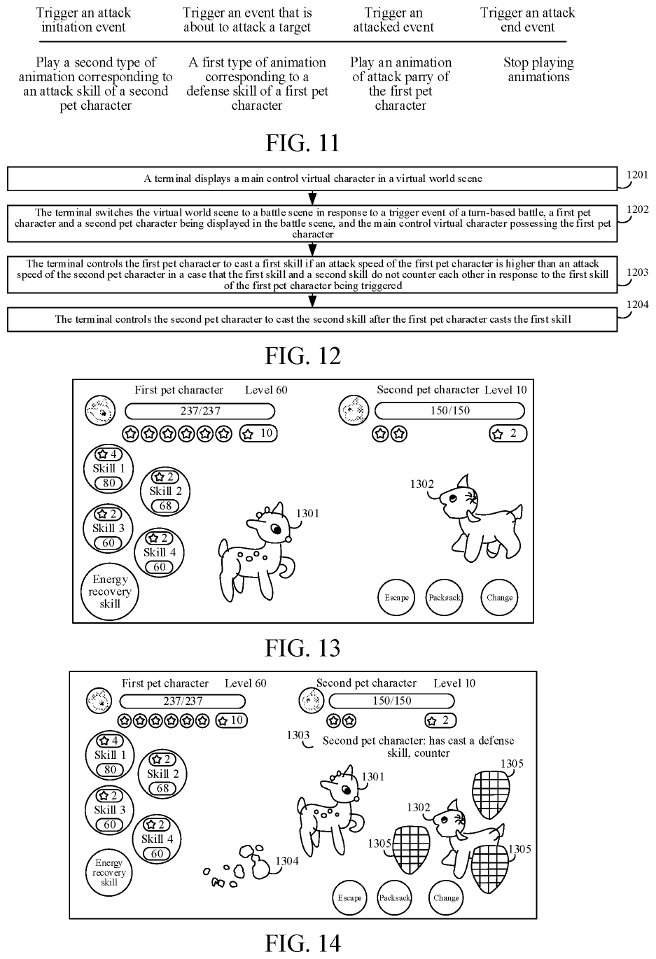

The foregoing embodiment is described by taking an example in which there is a countering relationship between the first skill and the second skill. However, in this embodiment of this application, there is no countering relationship between the first skill and the second skill. For a specific process, refer to the following embodiment. FIG. 12 is a flowchart of a battle method according to an embodiment of this application. For example, the method is performed by a terminal. As shown in FIG. 12, the method includes the following:

1201: A terminal displays a main control virtual character in a virtual world scene.

1202: The terminal switches the virtual world scene to a battle scene in response to a trigger event of a turn-based battle, a first pet character and a second pet character being displayed in the battle scene, and the main control virtual character possessing the first pet character.

Operations 1201 to 1202 are similar to operations 301 to 302 mentioned above. Details are not described herein again.

1203: The terminal controls the first pet character to cast a first skill if an attack speed of the first pet character is higher than an attack speed of the second pet character when the first skill and a second skill do not counter each other after the casting of the first skill by the first pet character being triggered.

In this embodiment of this application, in a turn-based battle process, when the first skill to be cast by the first pet character and the second skill to be cast by the second pet character do not counter each other, the first pet character and the second pet character respectively cast skills according to respective attack speeds, and the pet character having a high attack speed preferentially casts the skill. That the first skill and the second skill do not counter each other means that there is no countering relationship between the first skill and the second skill. For example, there is a countering relationship between different skill types, the first skill and the second skill belong to a same skill type, and there is no countering relationship between skills belonging to the same skill type.

In a implementation, the pet characters in the virtual world scene have two types of skills: skills of ordinary types and skills of responding types. The responding types include multiple skill types, and there is a countering relationship between different skill types in the responding types. The ordinary types may also include multiple skill types, but there is no countering relationship between different skill types in the ordinary types. The first skill and the second skill do not counter each other, indicating that the first skill and the second skill are both skills of ordinary types, or at least one of the first skill and the second skill is a skill of an ordinary type. In this embodiment of this application, for skills of the pet characters in the virtual world scene, the skills of the pet characters are classified into two types: skills of ordinary types and skills of responding types. There is a countering relationship between skills of different responding types. In the process of controlling the pet characters to battle against each other, if the skills cast by both parties do not have a countering relationship, each pet character is controlled to cast the skill according to the attack speed (that is, cast speed) of each pet character; and if the skills cast by both parties have a countering relationship, each pet character is controlled to cast the skill according to the countering relationship, and an additional skill effect can be obtained when a skill that counters another skill is cast.

1204: The terminal controls the second pet character to cast the second skill after the first pet character casts the first skill.

In this embodiment of this application, because the attack speed of the first pet character is higher than the attack speed of the second pet character, the first pet character preferentially casts the first skill, and the second pet character casts the second skill only after the first pet character casts the first skill, so that the sequence of casting the skill by each pet character is related to the magnitude of the attack speed of the pet character. In the solution provided in this embodiment of this application, in a turn-based battle process, when the first skill to be cast by the first pet character and the second skill to be cast by the second pet character do not counter each other, the first pet character and the second pet character respectively cast skills according to respective attack speeds, and the pet character having a high attack speed preferentially casts the skill, thereby enriching multiple battle possibilities of the game. In this way, the user not only needs to consider the countering relationship between the cast skills in the turn-based battle process, but also needs to increase the attack speed of the pet character as much as possible, so as to obtain a relatively high winning probability when the skills cast by the pet characters of both parties do not counter each other, so that the battle situation is diversified, the interaction effect between pet characters can be ensured, and the game experience of the user is ensured.

The embodiment shown in FIG. 12 above is described by taking an example in which the attack speed of the first pet character is higher than the attack speed of the second pet character. In another embodiment, after the casting of the first skill by the first pet character being triggered, when the first skill and the second skill do not counter each other, if the attack speed of the second pet character is higher than the attack speed of the first pet character, the second pet character is controlled to cast the second skill; and after the second pet character casts the second skill, the first pet character is controlled to cast the first skill.

Based on the foregoing embodiments, an embodiment of this application further provides a schematic diagram of a battle scene, as shown in FIG. 13 to FIG. 16. When a virtual world scene is switched to a battle scene, the battle scene is shown in FIG. 13. A first pet character 1301, a second pet character 1302, and a plurality of skill options, such as skill 1, skill 2, escape, packsack, change, and energy recovery skill, of the first pet character 1301 are displayed in the battle scene. An energy value consumed when each skill is cast and a damage value caused by the skill are displayed in skill options of skill 1, skill 2, skill 3, and skill 4. For example, the energy value consumed when the skill 1 is cast is 4, and the damage value caused by the skill is 80. In addition, brief introduction information of the first pet character 1301 and brief introduction information of the second pet character 1302 are further displayed in the battle scene. The brief introduction information of the first pet character 1301 can reflect that the health point of the first pet character 1301 is 237, the currently possessed energy value is 10, and the level is 60. The brief introduction information of the second pet character 1302 can reflect that the health point of the second pet character 1302 is 150, the currently possessed energy value is 2, and the level is 10.

Taking an example in which the second pet character 1302 is an artificial intelligence pet character, the user clicks/taps any skill option through the terminal, for example, clicks/taps the skill 2, where the skill 2 is an attack skill. In this case, the server determines that the skill to be cast is a defense skill for the second pet character 1302, and transmits an instruction instructing the second pet character 1302 to cast the defense skill to the terminal. In response to a trigger operation of the skill 2 and the instruction instructing the second pet character 1302 to cast the defense skill, the terminal plays the second type of animation for indicating that the first pet character 1301 casts the attack skill, so as to present a picture of the first pet character 1301 jumping from a current position to move to a position of the second pet character 1302. When the first pet character 1301 reaches above the second pet character 1302 and is about to attack the second pet character 1302, the playing speed of the second type of animation for indicating that the first pet character 1301 casts the attack skill is reduced, prompt information for indicating that the second pet character 1302 casts the defense skill is displayed, and the first type of animation for indicating that the second pet character 1302 casts the defense skill is played, so as to present a picture of the defense skill cast by the second pet character 1302. In this case, the battle scene is shown in FIG. 14. Prompt information 1303 is displayed in the battle scene, the first pet character 1301 has left an original position and approaches the second pet character 1302, a special effect 1304 indicating that the first pet character 1301 leaves is displayed at the original position of the first pet character 1301, a virtual shield 1305 is displayed around the second pet character 1302, and the virtual shield 1305 is configured to represent the defense skill cast by the second pet character.

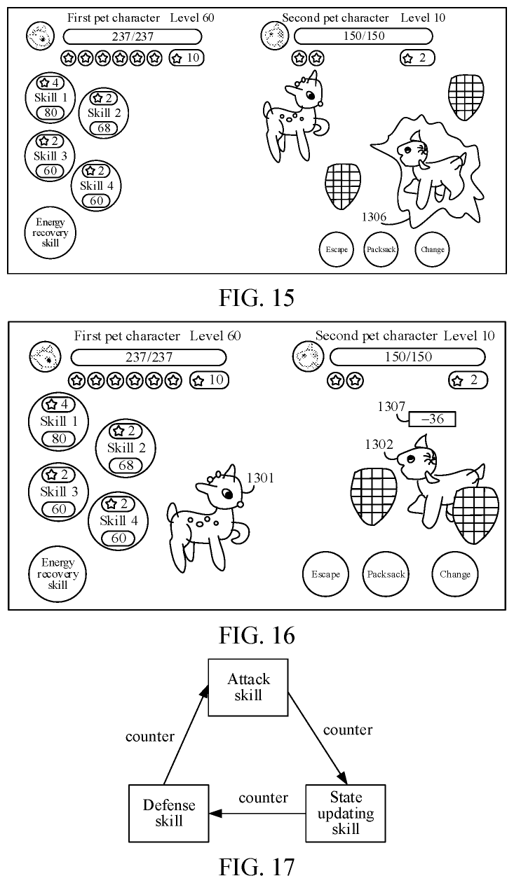

In the process of playing the first type of animation for indicating that the second pet character 1302 casts the defense skill, if the defense skill already cast by the second pet character 1302 is presented and a defense special effect is displayed around the second pet character 1302, the playing speed of the second type of animation for indicating that the first pet character 1301 casts the attack skill is recovered. In this case, a stage (that is, bullet time) in which the first pet character 1301 attacks the second pet character 1302 is performed. In this case, the battle scene is shown in FIG. 15. In the process of the first pet character 1301 attacking the second pet character 1302, an animation of attack parry of the second pet character 1302 is played. In this process, the second pet character 1302 is in a dominant state 1306, and an animation of attacking the second pet character 1302 is not played.

When the attack of the first pet character 1301 is completed, the battle scene is shown in FIG. 16. The first pet character 1301 returns to the position before the battle, and the picture of attack parry and defense of the second pet character 1302 is no longer displayed. That is, the first type of animation for indicating that the second pet character 1302 casts the defense skill and the second type of animation for indicating that the first pet character 1301 casts the attack skill are no longer played, and a damage value 1307 caused by attacking the second pet character 1302 this time is displayed. The damage value 1307 is less than the damage value indicated by the default effect of the attack skill of the first pet character 1301, so as to reflect an effect that the parry of the second pet character succeeds.

In this embodiment of this application, skills of responding types of pet characters are classified into three types: a skill of an attack type, a skill of a defense type, and a skill of a state updating type, that is, an attack skill, a defense skill, and a state updating skill. The countering relationships among the three skills are shown in FIG. 17. The attack skill overcomes the state updating skill, the state updating skill overcomes the defense skill, and the defense skill overcomes the attack skill. The three skill types achieve a cyclic counter among each other, so that when selecting the skill to be cast for the pet character, the player further needs to consider which skill the opposite party may cast, so as to avoid the countered situation as much as possible, or achieve the situation of countering the corresponding skill as much as possible, so that the strategy between both parties has a Nash equilibrium, and the strategy of the game is enhanced.

For any skill, a bonus effect generated when the skill overcomes another skill is matched with the skill type to which the skill belongs as much as possible, and can exceed the default effect of the skill. For example, if the damage value of a skill is 100, when the skill overcomes the skill of the opposite party, the damage value of the skill changes to 200 or even higher, so that an additional effect generated when the skill overcomes the skill of the opposite party can affect the battle situation. Thus, in the process of controlling the pet character to battle, the player can achieve an effect of turning the situation according to the countering relationship between skills, and a more powerful effect is a most direct encouraging means to make up for the previous passive situation.

In the solution provided in this embodiment of this application, in a turn-based battle process, the battle result is not only related to the capability of the pet character, for example, a higher defense value and a higher attack force of the pet character indicate a higher probability that the pet character will win in the battle process. In addition, the battle result may further be affected by the countering relationship between the skills cast by the pet characters of both parties in the battle. In each battle turn, because the countering relationship exists between the skills, a common decision of both parties (that is, the skills to be cast, selected for respective pet characters) may affect the battle result of the battle turn. For a skill that counters another skill, an additional skill effect generated when the skill is cast greatly affects the battle result, or even changes the battle result, so that the player may still have a possibility of turning the situation even if the current disadvantage of the player is significant in the battle process, and the possibility is very high. Consequently, the uncertainty of the battle result is high, and the interest of the user can be improved, thereby improving the user experience. In multiple turns of the turn-based battle, the variable of the battle result is kept, and the strategies of both parties are further considered when the skill to be cast is selected in each turn.

In addition, an embodiment of this application provides a strategy in a synchronous decision-making turn-based game. When the skills cast by the pet characters of both parties in the battle have a countering relationship, additional effects of the skills can be obtained, so as to affect the battle result. Due to the mechanism of the countering relationship between skills, the attack speed of the pet character is no longer a necessary condition for starting first, which greatly suppresses the priority of the attack speed in effort value allocation, thereby reducing the waste of overflow attributes. The effort value can increase multiple attribute values of the pet character. In addition, the animation is played according to the countering relationship between skills to reflect the situation that each pet character casts the skill. In this way, before the playing of the animation ends, the player cannot know the battle result of this turn.

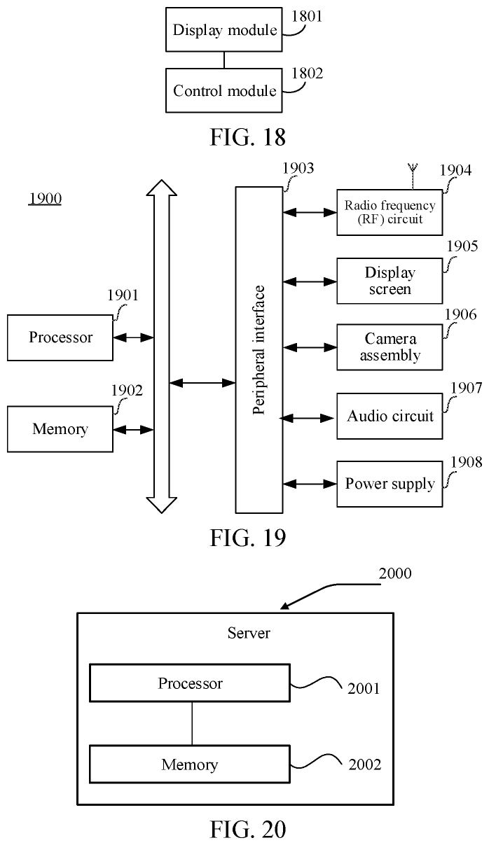

FIG. 18 is a schematic structural diagram of a battle apparatus according to an embodiment of this application. As shown in FIG. 18, the apparatus includes:
a display module 1801, configured to display a main control virtual character in a virtual world scene, where the display module 1801 is further configured to switch the virtual world scene to a battle scene in response to a trigger event of a turn-based battle, a first pet character and a second pet character being displayed in the battle scene, and the main control virtual character possessing the first pet character; and a control module 1802, configured to control the first pet character to cast the first skill with a bonus effect and control the second pet character to cast the second skill when the first skill overcomes the second skill to be cast by the second pet character after the casting of the first skill by the first pet character being triggered.

In a implementation, the control module 1802 is configured to control the second pet character to cast the second skill when the first skill overcomes the second skill after the casting of the first skill by the first pet character being triggered; and control the first pet character to cast the first skill with a bonus effect in response to a preset event being triggered in the process of the second pet character casting the second skill, the preset event indicating an interaction state between the second pet character and the first pet character or a duration of casting the second skill by the second pet character.

In another implementation, the control module 1802 is further configured to control the second pet character to suspend the cast of the second skill in response to the preset event being triggered.

In another implementation, the control module 1802 is configured to control the second pet character to cast the second skill with a weakening effect.

In another implementation, the control module 1802 is configured to control the first pet character to cast the first skill with a bonus effect and control the second pet character to cast the second skill when a first skill type is a preset overcoming type of a second skill type after the casting of the first skill by the first pet character being triggered, the first skill type being a skill type to which the first skill belongs, and the second skill type being a skill type to which the second skill belongs.

In another implementation, the first skill is an attack skill; and the control module 1802 is configured to control the first pet character to cast the attack skill to the second pet character, where an attribute weakening value caused by the attack skill to the second pet character is greater than a default attribute weakening value of the attack skill; or a number of attacks of the first pet character against the second pet character is higher than a default number of attacks of the attack skill.

In another implementation, the first skill is a defense skill, the second skill is an attack skill, and the control module 1802 is configured to control the first pet character to cast the defense skill with a bonus effect, and control the second pet character to cast the attack skill against the first pet character, where an attribute weakening value caused by the attack skill to the first pet character is less than a default attribute weakening value of the attack skill; or a number of attacks of the second pet character against the first pet character is less than a default number of attacks of the attack skill.

In another implementation, the first skill is a defense skill, the second skill is an attack skill, and the control module 1802 is configured to control the second pet character to cast the attack skill against the first pet character, and control the first pet character to cast the defense skill; and control the first pet character to counterattack the second pet character when the attack of the second pet character is completed.

In another implementation, the first skill is a state updating skill; and the control module 1802 is configured to perform at least one of the following:
controlling the first pet character to cast the state updating skill with a bonus effect to the first pet character, the state updating skill being configured for enhancing the state of the first pet character; and
controlling the first pet character to cast the state updating skill with a bonus effect to the second pet character, the state updating skill being configured for weakening the state of the second pet character.

In another implementation, the control module 1802 is configured to perform at least one of the following:
controlling the first pet character to cast the first skill with a default effect, and reducing an energy value possessed by the second pet character, the energy value being configured for casting a skill;
controlling the first pet character to cast the first skill with a default effect, and increasing an energy value possessed by the first pet character;
controlling the first pet character to cast the first skill with a default effect, and controlling the second pet character to suspend the cast of the second skill;
controlling the first pet character to cast the first skill with a default effect, and reducing an attribute value of the second pet character;
controlling the first pet character to cast the first skill with a default effect, and increasing an attribute value of the first pet character;
controlling the first pet character to cast the first skill with a default effect, and reducing an energy value consumed when the skill of the first pet character is cast;
controlling the first pet character to cast the first skill with a default effect, and increasing an energy value consumed when the skill of the second pet character is cast;
controlling the first pet character to cast the first skill with a default effect, and reducing a cooling duration of the skill of the first pet character;
controlling the first pet character to cast the first skill with a default effect, and increasing a cooling duration of the skill of the second pet character;
controlling the first pet character to cast the first skill with a default effect when the first skill is not an object change skill, and switching the first pet character to a third pet character when the interaction between the first pet character and the second pet character is completed, the main control virtual character possessing the third pet character;
controlling the first pet character to cast the first skill with a default effect when the first pet character is in a weakened state, and reducing a unit amplitude corresponding to the weakened state, the weakened state being configured for gradually reducing an attribute value of the first pet character according to the corresponding unit amplitude;
controlling the first pet character to cast the first skill with a default effect, and determining a difference between a first energy value and a second energy value as an energy value consumed when the first skill is cast this time, the first energy value being an energy value consumed when the first skill is cast, and the second energy value being an energy value consumed when the second skill is cast; and
controlling the first pet character to cast the first skill with a default effect in a current turn when the first pet character casts the skill of a preset skill type in the previous turn, an energy value consumed when the first skill is cast in the current turn being reduced.

In another implementation, the control module 1802 is configured to display that the second pet character is in a weakened state and the attribute value of the second pet character gradually decreases.

In another implementation, the control module 1802 is configured to display that the first pet character is in a gain state and the attribute value of the first pet character gradually increases.

In another implementation, the control module 1802 is further configured to control the first pet character to cast the first skill and control the second pet character to cast the second skill with a bonus effect when the second skill overcomes the first skill after the casting of the first skill by the first pet character being triggered.

In another implementation, the first skill corresponds to a first type of animation and a second type of animation, and the second skill corresponds to a first type of animation and a second type of animation; the first type of animation corresponding to the first skill is configured for displaying a picture of the first pet character casting the first skill with a bonus effect, and the second type of animation corresponding to the first skill is configured for displaying a picture of the first pet character casting the first skill; the first type of animation corresponding to the second skill is configured for displaying a picture of the second pet character casting the second skill with a bonus effect, and the second type of animation corresponding to the second skill is configured for displaying a picture of the second pet character casting the second skill; and the control module 1802 is configured to play the first type of animation corresponding to the first skill and the second type of animation corresponding to the second skill when the first skill overcomes the second skill after the casting of the first skill by the first pet character being triggered.

In another implementation, the control module 1802 is configured to play the second type of animation corresponding to the second skill when the first skill overcomes the second skill after the casting of the first skill by the first pet character being triggered; and play the first type of animation corresponding to the first skill in response to a preset event being triggered in the process of playing the second type of animation corresponding to the second skill, the preset event indicating an interaction state between the second pet character and the first pet character or a playing duration of the second type of animation corresponding to the second skill.

In another implementation, the first skill is a defense skill, the second skill is an attack skill, and the control module 1802 is configured to play the first type of animation corresponding to the first skill when the second pet character is about to attack the first pet character; and the control module 1802 is further configured to play an animation of attack parry of the first pet character in the process of the second pet character attacking the first pet character.

In another implementation, the duration of the first type of animation corresponding to the first skill is less than the duration of the second type of animation corresponding to the second skill; and the control module 1802 is further configured to repeatedly play the first type of animation corresponding to the first skill if the playing of the first type of animation corresponding to the first skill ends in the process of playing the second type of animation corresponding to the second skill.

In another implementation, the control module 1802 is further configured to control the first pet character to cast the first skill if the attack speed of the first pet character is higher than the attack speed of the second pet character when the first skill and the second skill do not counter each other after the casting of the first skill by the first pet character being triggered; and control the second pet character to cast the second skill after the first pet character casts the first skill.

In another implementation, the control module 1802 is configured to control the first pet character to cast the first skill with a bonus effect when an energy value possessed by the first pet character is not less than a value corresponding to the first skill, and reduce the energy value possessed by the first pet character by the value corresponding to the first skill, the value corresponding to the first skill being an energy value consumed when the first skill is cast.

In another implementation, the control module 1802 is further configured to perform at least one of the following:
increasing the energy value possessed by the first pet character when the first pet character is located in an energy recovery area in the virtual world scene;
increasing the energy value possessed by the first pet character when the battle between the first pet character and the second pet character ends;
increasing the energy value possessed by the first pet character in response to the first pet character casting an energy recovery skill; and
increasing the energy value possessed by the first pet character when the main control virtual character is located in a record storage area in the virtual world scene.

In another implementation, the control module 1802 is further configured to perform at least one of the following:
displaying that the energy value possessed by the first pet character gradually increases when the first pet character is located in the energy recovery area; and
displaying that the energy value possessed by the first pet character is increased by a preset value when the first pet character is located in the energy recovery area.

The battle apparatus provided in the foregoing embodiments is illustrated only with an example of division of the foregoing function modules. In practical applications, the foregoing functions may be allocated to and completed by different function modules according to requirements. That is, an internal structure of the computer device is divided into different function modules to complete all or some of the functions described above. In addition, the battle apparatus provided in the foregoing embodiments and the battle method embodiments belong to the same concept. For the specific implementation process, refer to the method embodiments. No further details will be given herein.

An embodiment of this application further provides a computer device, including a processor and a memory, the memory having at least one computer program stored therein, and the at least one computer program being loaded and executed by the processor to implement operations performed in the battle method in the foregoing embodiments. In some embodiments, the computer device is provided as a terminal. FIG. 19 is a structural block diagram of a terminal 1900 according to an exemplary embodiment of this application. The terminal 1900 includes: a processor 1901 and a memory 1902. In some embodiments, the terminal 1900 may exemplarily include: a peripheral interface 1903 and at least one peripheral device. The processor 1901, the memory 1902, and the peripheral interface 1903 may be connected by a bus or a signal line. Each peripheral device may be connected to the peripheral interface 1903 by a bus, a signal line, or a circuit board. Specifically, the peripheral device includes: at least one of a radio frequency (RF) circuit 1904, a display screen 1905, a camera assembly 1906, an audio circuit 1907, and a power supply 1908.

The peripheral interface 1903 may be configured to connect at least one peripheral device related to an input/output (I/O) to the processor 1901 and the memory 1902. The RF circuit 1904 is configured to receive and transmit an RF signal which is also referred to as an electromagnetic signal. The RF circuit 1904 communicates with a communication network and other communication devices through the electromagnetic signal. The RF circuit 1904 converts an electrical signal into an electromagnetic signal for transmission, or converts a received electromagnetic signal into an electrical signal. The display screen 1905 is configured to display a UI. The UI may include graphics, text, icons, videos, and any combination thereof. When the display screen 1905 is a touch display screen, the display screen 1905 further has a capability of acquiring a touch signal on or above a surface of the display screen 1905. The touch signal may be inputted, as a control signal, into the processor 1901 for processing. In this case, the display screen 1905 may be further configured to provide a virtual button and/or a virtual keyboard, which is also referred to as a soft button and/or a soft keyboard. The camera assembly 1906 is configured to collect images or videos. In some embodiments, the camera assembly 1906 includes a front camera and a rear camera. The front camera is arranged on a front panel of the terminal, and the rear camera is arranged on a back of the terminal. The audio circuit 1907 may include a microphone and a speaker. The microphone is configured to collect sound waves of a user and an environment, and convert the sound waves into electrical signals to be inputted to the processor 1901 for processing, or inputted to the RF circuit 1904 for implementing voice communication. The speaker is configured to convert the electrical signals from the processor 1901 or the RF circuit 1904 into sound waves. The power supply 1908 is configured to supply power to components in the terminal 1900.

A person skilled in the art may understand that the structure shown in FIG. 19 does not constitute a limitation on the terminal 1900. The terminal may include more or fewer components than those shown in the figure, or some merged components, or different component arrangements.

In some embodiments, the computer device is provided as a server. FIG. 20 is a schematic structural diagram of a server according to an embodiment of this application. A server 2000 may vary considerably in configuration or performance, and may include one or more central processing units (CPUs) 2001 and one or more memories 2002. The memory 2002 has at least one computer program stored therein, and the at least one computer program is loaded and executed by the processor 2001 to implement the method provided in each of the foregoing method embodiments. Of course, the server may further have components such as a wired or wireless network interface, a keyboard, and an input/output interface for input and output. The server may further include other components for achieving device functions. Details are not described herein.

An embodiment of this application further provides a computer-readable storage medium, having at least one computer program stored therein, the at least one computer program being loaded and executed by a processor to implement operations performed in the battle method in the foregoing embodiments. An embodiment of this application further provides a computer program product, including a computer program, the computer program, when executed by a processor, implementing operations performed in the battle method in the foregoing embodiments.

A person of ordinary skill in the art may understand that all or part of the operations of implementing the foregoing embodiments may be implemented by hardware, or may be implemented by a program instructing related hardware. The program may be stored in a computer-readable storage medium. The foregoing storage medium may be a read-only memory, a magnetic disk, an optical disc, or the like.

The above descriptions are merely exemplary embodiments in the embodiments of this application, and are not intended to limit the embodiments of this application. Any modification, equivalent replacement, improvement, or the like made within the spirit and principle of the embodiments of this application falls within the protection scope of this application.

What is claimed is:

1. A method for managing a batter between two virtual characters performed by a computer device, the method comprising:
displaying a main control virtual character in a virtual world scene;
in response to a trigger event of a turn-based battle, switching the virtual world scene to a battle scene including a first pet character and a second pet character, and the main control virtual character possessing the first pet character;
in response to the main control virtual character triggering a first skill of the first pet character, determining a second skill to be cast by the second pet character; and
when the first skill overcomes the second skill to be cast by the second pet character, controlling the first pet character to cast the first skill with a bonus effect and controlling the second pet character to cast the second skill.

2. The method according to claim 1, wherein the controlling the first pet character to cast the first skill with the bonus effect and controlling the second pet character to cast the second skill comprises:
controlling the second pet character to cast the second skill after the casting of the first skill by the first pet character; and
in a process of the second pet character casting the second skill, controlling the first pet character to cast the first skill with the bonus effect in response to a preset event being triggered, the preset event indicating an interaction state between the second pet character and the first pet character or a duration of casting the second skill by the second pet character.

3. The method according to claim 2, further comprising:
controlling the second pet character to suspend the cast of the second skill in response to the preset event being triggered.

4. The method according to claim 1, wherein the controlling the second pet character to cast the second skill comprises:
controlling the second pet character to cast the second skill with a weakening effect.

5. The method according to claim 1, wherein the controlling the first pet character to cast the first skill with the bonus effect and controlling the second pet character to cast the second skill comprises:
when a first skill type of the first skill is a preset overcoming type of a second skill type of the second skill in response to the first skill of the first pet character being triggered, controlling the first pet character to cast the first skill with the bonus effect and controlling the second pet character to cast the second skill.

6. The method according to claim 1, wherein the first skill is an attack skill; and the controlling the first pet character to cast the first skill with the bonus effect comprises:
controlling the first pet character to cast the attack skill to the second pet character, wherein the bonus effect is that:
an attribute weakening value caused by the attack skill to the second pet character is greater than a default attribute weakening value of the attack skill; or a number of attacks of the first pet character against the second pet character is higher than a default number of attacks of the attack skill.

7. The method according to claim 1, wherein the first skill is a defense skill, the second skill is an attack skill, and the controlling the first pet character to cast the first skill with the bonus effect and controlling the second pet character to cast the second skill comprises:
controlling the first pet character to cast the defense skill with the bonus effect, and controlling the second pet character to cast the attack skill against the first pet character, wherein the bonus effect is that:
an attribute weakening value caused by the attack skill to the first pet character is less than a default attribute weakening value of the attack skill; or a number of attacks of the second pet character against the first pet character is less than a default number of attacks of the attack skill.

8. The method according to claim 1, wherein the first skill is a defense skill, the second skill is an attack skill, and the controlling the first pet character to cast the first skill with the bonus effect and controlling the second pet character to cast the second skill comprises:
controlling the second pet character to cast the attack skill against the first pet character, and controlling the first pet character to cast the defense skill against the second pet character; and
controlling the first pet character to counterattack the second pet character when an attack of the second pet character is completed.

9. The method according to claim 1, wherein the first skill is a state updating skill; and
the controlling the first pet character to cast the first skill with the bonus effect comprises at least one of the following:
controlling the first pet character to cast the state updating skill with the bonus effect to the first pet character, the state updating skill being configured for enhancing a state of the first pet character; and
controlling the first pet character to cast the state updating skill with the bonus effect to the second pet character, the state updating skill being configured for weakening a state of the second pet character.

10. The method according to claim 1, wherein the controlling the first pet character to cast the first skill with the bonus effect comprises at least one of the following:
controlling the first pet character to cast the first skill with a default effect, and reducing an energy value possessed by the second pet character, the energy value being configured for casting a skill;
controlling the first pet character to cast the first skill with a default effect, and increasing an energy value possessed by the first pet character;
controlling the first pet character to cast the first skill with a default effect, and controlling the second pet character to suspend the cast of the second skill;
controlling the first pet character to cast the first skill with a default effect, and reducing an attribute value of the second pet character;
controlling the first pet character to cast the first skill with a default effect, and increasing an attribute value of the first pet character;
controlling the first pet character to cast the first skill with a default effect, and reducing an energy value consumed when the skill of the first pet character is cast;
controlling the first pet character to cast the first skill with a default effect, and increasing an energy value consumed when the skill of the second pet character is cast;
controlling the first pet character to cast the first skill with a default effect, and reducing a cooling duration of the skill of the first pet character;
controlling the first pet character to cast the first skill with a default effect, and increasing a cooling duration of the skill of the second pet character;
controlling the first pet character to cast the first skill with a default effect when the first skill is not an object change skill, and switching the first pet character to a third pet character when an interaction between the first pet character and the second pet character is completed, the main control virtual character possessing the third pet character;
controlling the first pet character to cast the first skill with a default effect when the first pet character is in a weakened state, and reducing a unit amplitude corresponding to the weakened state, the weakened state being configured for gradually reducing the attribute value of the first pet character according to the corresponding unit amplitude;
controlling the first pet character to cast the first skill with a default effect, and determining a difference between a first energy value and a second energy value as an energy value consumed when the first skill is cast this time, the first energy value being an energy value consumed when the first skill is cast, and the second energy value being an energy value consumed when the second skill is cast; and
controlling the first pet character to cast the first skill with a default effect in a current turn when the first pet character casts a skill of a preset skill type in a previous turn, an energy value consumed when the first skill is cast in the current turn being reduced.

11. The method according to claim 1, wherein the method further comprises:
controlling the first pet character to cast the first skill when an attack speed of the first pet character is higher than an attack speed of the second pet character when the first skill and the second skill do not counter each other; and
controlling the second pet character to cast the second skill after the first pet character casts the first skill.

12. The method according to claim 1, wherein the controlling the first pet character to cast the first skill with the bonus effect comprises:
when an energy value possessed by the first pet character is not less than a value corresponding to the first skill, controlling the first pet character to cast the first skill with the bonus effect and reducing the energy value possessed by the first pet character by the value corresponding to the first skill, the value corresponding to the first skill being an energy value consumed when the first skill is cast.

13. A computer device, comprising a processor and a memory, the memory having at least one computer program stored therein, and the at least one computer program, when loaded and executed by the processor, causing the computer device to implement a method for managing a batter between two virtual characters including:
displaying a main control virtual character in a virtual world scene;
in response to a trigger event of a turn-based battle, switching the virtual world scene to a battle scene including a first pet character and a second pet character, and the main control virtual character possessing the first pet character;
in response to the main control virtual character triggering a first skill of the first pet character, determining a second skill to be cast by the second pet character; and
when the first skill overcomes the second skill to be cast by the second pet character, controlling the first pet character to cast the first skill with a bonus effect and controlling the second pet character to cast the second skill.

14. The computer device according to claim 13, wherein the controlling the first pet character to cast the first skill with the bonus effect and controlling the second pet character to cast the second skill comprises:
controlling the second pet character to cast the second skill after the casting of the first skill by the first pet character; and
in a process of the second pet character casting the second skill, controlling the first pet character to cast the first skill with the bonus effect in response to a preset event being triggered, the preset event indicating an interaction state between the second pet character and the first pet character or a duration of casting the second skill by the second pet character.

15. The computer device according to claim 14, wherein the method further comprises:
controlling the second pet character to suspend the cast of the second skill in response to the preset event being triggered.

16. The computer device according to claim 13, wherein the controlling the second pet character to cast the second skill comprises:
controlling the second pet character to cast the second skill with a weakening effect.

17. The computer device according to claim 13, wherein the controlling the first pet character to cast the first skill with the bonus effect and controlling the second pet character to cast the second skill comprises:
when a first skill type of the first skill is a preset overcoming type of a second skill type of the second skill in response to the first skill of the first pet character being triggered, controlling the first pet character to cast the first skill with the bonus effect and controlling the second pet character to cast the second skill.

18. The computer device according to claim 13, wherein the first skill is an attack skill; and the controlling the first pet character to cast the first skill with the bonus effect comprises:
controlling the first pet character to cast the attack skill to the second pet character, wherein the bonus effect is that:
an attribute weakening value caused by the attack skill to the second pet character is greater than a default attribute weakening value of the attack skill; or a number of attacks of the first pet character against the second pet character is higher than a default number of attacks of the attack skill.

19. The computer device according to claim 13, wherein the first skill is a defense skill, the second skill is an attack skill, and the controlling the first pet character to cast the first skill with the bonus effect and controlling the second pet character to cast the second skill comprises:
controlling the first pet character to cast the defense skill with the bonus effect, and controlling the second pet character to cast the attack skill against the first pet character, wherein the bonus effect is that:
an attribute weakening value caused by the attack skill to the first pet character is less than a default attribute weakening value of the attack skill; or a number of attacks of the second pet character against the first pet character is less than a default number of attacks of the attack skill.

20. A non-transitory computer-readable storage medium, having at least one computer program stored therein, and the at least one computer program, when loaded and executed by a processor of a computer device, causing the computer device to implement a method for managing a batter between two virtual characters including:
displaying a main control virtual character in a virtual world scene;
in response to a trigger event of a turn-based battle, switching the virtual world scene to a battle scene including a first pet character and a second pet character, and the main control virtual character possessing the first pet character;
in response to the main control virtual character triggering a first skill of the first pet character, determining a second skill to be cast by the second pet character; and
when the first skill overcomes the second skill to be cast by the second pet character, controlling the first pet character to cast the first skill with a bonus effect and controlling the second pet character to cast the second skill.
